(19) United States
(12) Patent Application Publication
(10) Pub. No.: US 2024/0220997 A1
(43) Pub. Date: Jul. 4, 2024

(54) COMPUTERIZED-METHOD AND REAL-TIME INFORMATION SHARING (RTIS) PLATFORM FOR MAINTAINING A DYNAMIC KNOWLEDGE BASE

(71) Applicant: inContact INC., Sandy, UT (US)

(72) Inventors: Harini SEETHARAMAN, Andalpuram (IN); Mahesh BHASKARAN, REDMOND, WA (US); Ragahvendra B K, Mysore (IN)

(21) Appl. No.: 18/092,321

(22) Filed: Jan. 1, 2023

(51) Int. Cl. G06Q 30/015

(52) U.S. Cl. CPC G06Q 30/015

(57) ABSTRACT

A Real-Time Information Sharing (RTIS) platform for maintaining a dynamic knowledge base is provided herein. The RTIS platform includes a RTIS engine. The RTIS engine includes (i) detecting termination of a first-interaction of a first-user to display via a GUI, an option to mark information as to a resolution to a problem that has been provided during the first-interaction for entering the resolution to a RTIS entry; (ii) receiving a marked RTIS entry via the GUI from the first-user and storing the marked RTIS entry in the RTI database; (iii) retrieving a batch of RTIS entries to calculate a score for each RTIS entry in the batch, based on one or more parameters; (iv) displaying a preconfigured number of RTIS entries via the GUI based on the calculated score of the RTIS entries upon receiving a request for display, when a second interaction of a second-user starts.

### TECHNICAL FIELD

The present disclosure relates to the field of computerized systems and methods for maintaining a dynamic knowledge base.

### BACKGROUND

Current systems provide access for users to explicit information in the form of formal and systematic documents, i.e., knowledge base, which may be out-of-context in rapidly changing business environments. Consequently, users may not have up-to-date information which may adversely affect their performance. For example, delay in providing relevant response and lack of first-time resolution to customer service requests, which may deteriorate overall customers experience and satisfaction.

Lack of up-to-date, real-time information across users, such as agents in a contact center, has negative effect on the performance of the users. According to HubSpot Research, an American developer and marketer of software products for inbound marketing, sales and customer service, 90% of customers rate an “immediate” response as essential or very important when they have a customer service question and 60% of customers define “immediate”, as 10 minutes or less.

Accordingly, there is a need for a platform and method for maintaining dynamic knowledge base. In other words, there is a need in a technical solution for maintaining a dynamic knowledge base in addition to a static one.

### SUMMARY

There is thus provided, in accordance with some embodiments of the present disclosure, a Real-Time Information Sharing (RTIS) platform for maintaining a dynamic knowledge base.

In accordance with some embodiments of the present disclosure, the RTIS platform includes: a computer system having one or more processors, a Real-Time Information (RTI) database, a plurality of computerized-devices. Each computerized-device of the plurality of computerized devices is associated with a user of a plurality of users, and the computer system is configured to communicate with each computerized-device in the plurality of computerized-devices.

Furthermore, in accordance with some embodiments of the present disclosure, the one or more processors may be configured to operate a Real-Time Information Sharing (RTIS) engine. The RTIS engine includes: (i) detecting termination of a first interaction of a first user to display via a Graphical User Interface (GUI) that may be presented on a display unit, an option to mark information as to a resolution to a problem that has been provided during the first interaction for entering the resolution to a RTIS entry; (ii) receiving a marked RTIS entry via the GUI from the first user and storing the marked RTIS entry in the RTI database, the display unit is associated to a computerized-device in the plurality of computerized-devices; (iii) retrieving a batch of RTIS entries from the RTI database to calculate a score for each RTIS entry in the batch, based on one or more parameters. The score indicates relevance, recency and line of business of information in the RTIS entry, and (iv) displaying a preconfigured number of RTIS entries via the GUI based on the calculated score of the RTIS entries upon receiving a request for display, when a second interaction of a second user starts.

Furthermore, in accordance with some embodiments of the present disclosure, each RTIS entry includes information that has been provided to a customer during the first interaction. The information may not be included in a static knowledge base.

Furthermore, in accordance with some embodiments of the present disclosure, the RTIS entries may be filtered based on creation date, subject and line of business.

Furthermore, in accordance with some embodiments of the present disclosure, the RTIS entries may be displayed from recent date to old date, and the subject and the line of business may be selected by the second user.

Furthermore, in accordance with some embodiments of the present disclosure, the displayed RTIS entries may be RTIS entries having highest scores.

Furthermore, in accordance with some embodiments of the present disclosure, the calculating of the score of each entry may be by formula I:

score=(a) relevance score*weightage1+(b) recency score*weightage2+(c) line-of-business score*weightage3, (I)
whereby:
(a) relevance score is a sum of: (i) agent feedback score; (ii) dynamic context score, (iii) interaction category score; and (iv) interaction keyword score,
the agent feedback score is calculated by formula II:

agent feedback score=number of votes/max_votes*agent feedback weightage, (II)
whereby:
number of votes is a number of upvotes subtracted by a number of downvotes,
max_votes is a maximum number of votes from top preconfigured number of RTIS entries, and agent feedback weightage is a configurable weight,
the dynamic context score is calculated by formula III:

dynamic context score=number of interactions per department/max interactions in a department in the batch*dynamic context weight, (III)
the interaction category score equals ‘1’ when interaction category of RTIS entry matches interaction category of the second interaction and when interaction category of RTIS entry doesn't match interaction category of the second interaction, interaction category score equals ‘0’,
the interaction keyword score is calculated by formula IV:

interaction keyword score=number of words in the stored RTIS entry which matches a subcategory of the interaction/total number of words in the subcategory of the interaction*interaction keyword weightage, the sum of agent feedback weightage,dynamic context weight,recency weightage and interaction keyword weightage equals ‘1’, (IV)
(b) the recency score is calculated by summing recency entry score and duration score
whereby:
recency entry score is calculated by formula V:

recency entry score=preconfigured number of recent entries/(recency weightage*100) (V)
duration score is calculated by formula VI:

duration score=duration of interaction of the RTIS entry/maximum duration of interaction in the batch*duration weightage, (VI)
the sum of recency weightage, and duration weightage equals ‘1’,
(c) the line-of-business score is calculated by summing line of contact score*line of contact weightage, department score*department weightage, and region score*region weightage,
whereby:
line of contact score equals ‘1’ when line of contact of RTIS entry matches interaction line of contact of the second interaction and when interaction line of contact of RTIS entry doesn't match interaction line of contact of the second interaction line of contact score equals ‘0’,
department score equals ‘1’ when department of RTIS entry matches department of the second interaction and when department of RTIS entry doesn't match department of the second interaction department score, equals ‘0’, and region score equals ‘1’ when region of RTIS entry matches region of the second interaction and when region of RTIS entry doesn't match region of the second interaction, region score equals ‘0’, and the sum of line of contact weightage, department weightage and region weightage equals ‘1’. The sum of weightage1, weightage2 and weightage 3 equals ‘1’

Furthermore, in accordance with some embodiments of the present disclosure, the RTIS engine may further include displaying via the GUI, that is presented on a display unit, an option to pin RTIS entries to be included in the preconfigured number of RTIS entries regardless of the score of the RTIS entry.

Furthermore, in accordance with some embodiments of the present disclosure, the RTIS engine may further include updating the relevance score of the RTIS entries every preconfigured time.

Furthermore, in accordance with some embodiments of the present disclosure, the option to mark information that has been provided during the interaction for conversion to a RTIS entry may be displayed based on duration of the interaction and context thereof.

Furthermore, in accordance with some embodiments of the present disclosure, the RTIS engine may further include receiving a supervisor approval before the receiving of the RTIS entry via the GUI from the first user.

Furthermore, in accordance with some embodiments of the present disclosure, the RTIS engine may further include enabling a user to vote up or vote down, via the GUI, for each displayed RTIS entry.

Furthermore, in accordance with some embodiments of the present disclosure, the RTIS engine may further include checking every preconfigured time-interval the calculated score of RTIS entries which were received in last preconfigured time-interval to determine a preconfigured percentage of the RTIS entries having highest score. The determined preconfigured percentage of the RTIS entries may be sent to an invoked expert Application Programming Interface (API) for creating a how-to article from the determined RTIS entries.

There is further provided, in accordance with some embodiments of the present invention, a computerized-method for maintaining a dynamic knowledge base via a Real-Time Information Sharing (RTIS) platform. The computerized-method may include (i) detecting termination of a first interaction of a first user to display via a Graphical User Interface (GUI) that is presented on a display unit, an option to mark information as to a resolution to a problem that has been provided during the first interaction for entering the resolution to a RTIS entry; (ii) receiving a marked RTIS entry via the GUI from the first user and storing the marked RTIS entry in the RTI database. The display unit may be associated to a computerized-device in the plurality of computerized-devices; (iii) retrieving a batch of RTIS entries from the RTI database to calculate a score for each RTIS entry in the batch, based on one or more parameters. The score indicates relevance, recency and line of business of information in the RTIS entry; and (iv) displaying a preconfigured number of RTIS entries via the GUI based on the calculated score of the RTIS entries upon receiving a request for display, when a second interaction of a second user starts.

### BRIEF DESCRIPTION OF THE DRAWINGS

In order for the present invention, to be better understood and for its practical applications to be appreciated, the following Figures are provided and referenced hereafter. It should be noted that the Figures are given as examples only and in no way limit the scope of the invention. Like components are denoted by like reference numerals.

FIG. 1 schematically illustrates a high-level diagram of a Real-Time Information Sharing (RTIS) platform for maintaining a dynamic knowledge base, in accordance with some embodiments of the present invention;

FIGS. 2A-2B is a high-level workflow of operations for maintaining a dynamic knowledge base via a Real-Time Information Sharing (RTIS) platform, in accordance with some embodiments of the present invention;

FIG. 3 schematically illustrates a high-level workflow of the information within the RTIS platform, in accordance with some embodiments of the present invention;

FIG. 4 schematically illustrates a high-level workflow for an RTIS entry, in accordance with some embodiments of the present invention;

FIG. 5 schematically illustrates a high-level workflow for displaying RTIS entries to agents, in accordance with some embodiments of the present invention;

FIG. 6 schematically illustrates a high-level workflow for pinning most relevant and recent RTIS entries in the database, in accordance with some embodiments of the present invention;

FIG. 7 schematically illustrates a high-level workflow for relevancy score adjustment by the RTIS engine, in accordance with some embodiments of the present invention;

FIG. 8 schematically illustrates a high-level workflow of a process of feedback loop of agents, in accordance with some embodiments of the present invention;

FIG. 9 is an example of expert knowledge base article type, in accordance with some embodiments of the present invention;

FIG. 10 is an example of an RTIS entry, in accordance with some embodiments of the present invention;

FIGS. 11A-11B are an example of two consecutive API calls for creating an article in Expert knowledge base, in accordance with some embodiments of the present invention;

FIG. 12 a high-level workflow of RTIS score calculation, in accordance with some embodiments of the present invention;

FIGS. 13A-13F are examples of configuration files used in RTIS score calculation, in accordance with some embodiments of the present invention;

FIG. 14A is an example of an interaction that may become an RTIS entry, in accordance with some embodiments of the present invention;

FIG. 14B is an example of an interaction that can become an RTIS entry, in accordance with some embodiments of the present invention;

FIG. 14C is an example of an RTIS entry table, in accordance with some embodiments of the present invention;

FIG. 14D is an example of interaction context, in accordance with some embodiments of the present invention;

FIG. 14E is an example of relevance score for each RTIS entry, in accordance with some embodiments of the present invention;

FIG. 15A is an example of agent feedback score calculation, in accordance with some embodiments of the present invention;

FIG. 15B is an example of number of interactions in each department, in accordance with some embodiments of the present invention;

FIG. 15C is an example of dynamic context score calculation, in accordance with some embodiments of the present invention;

FIG. 15D is an example of RTIS entries of login department and the dynamic context score, in accordance with some embodiments of the present invention;

FIG. 16A is an example of a new interaction for which a RTIS score will be calculated, in accordance with some embodiments of the present invention;

FIG. 16B is an example of RTIS entries with scores calculated and updated, in accordance with some embodiments of the present invention;

FIG. 16C is an example of relevance score calculation, in accordance with some embodiments of the present invention;

FIG. 16D is an example of duration in minutes of an interaction of existing RTIS entries, in accordance with some embodiments of the present invention;

FIG. 16E is an example of duration score calculation, in accordance with some embodiments of the present invention;

FIG. 17A is an example of interaction, in accordance with some embodiments of the present invention;

FIG. 17B is an example of selected RTIS entries for an interaction, in accordance with some embodiments of the present invention;

FIG. 18A is an example of a screenshot of a GUI of an RTIS board containing contextual information, in accordance with some embodiments of the present invention; and

FIG. 18B is an example of a screenshot of a GUI of an RTIS entry, in accordance with some embodiments of the present invention.

### DETAILED DESCRIPTION

In the following detailed description, numerous specific details are set forth in order to provide a thorough understanding of the disclosure. However, it will be understood by those of ordinary skill in the art that the disclosure may be practiced without these specific details. In other instances, well-known methods, procedures, components, modules, units and/or circuits have not been described in detail so as not to obscure the disclosure.

Although embodiments of the disclosure are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium (e.g., a memory) that may store instructions to perform operations and/or processes.

Although embodiments of the disclosure are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently. Unless otherwise indicated, use of the conjunction “or” as used herein is to be understood as inclusive (any or all of the stated options).

The terms “line of business” as used herein refers to a company line of business, such as banking, infrastructure, insurance etc.

The term “line of contact” as used herein refers to the point from which a customer places the interaction to the corresponding company. For example, in banking company, the line of contacts will be like credit card, debit card, loans etc.

The terms ‘factor’ and ‘score’ are interchangeable.

In current contact centers, agents have access to explicit information in the form of formal and systematic documents, which might be out-of-context in rapidly changing business environments. Also, agents in contact centers do not have up-to-date information which adversely affects their performance. A delay in providing relevant response and resolution during an interaction, deteriorates overall customer experience.

Lack of up-to-date, real-time information across agents may have a negative effect on the performance of agents in the contact center. The agents have access to explicit information, i.e., formal and systematic documents, which will be out of context in a dynamic business environment. Delay in providing relevant response to customers and lack of first-time resolution to customer service requests deteriorate overall Customer Satisfaction. 90% of customers rate an “immediate” response as essential or very important when they have a customer service question. 60% of customers define “immediate” as 10 minutes or less, according to HubSpot Research.

Accordingly, there is a need for a technical solution to facilitate sharing of dynamic knowledge that one gains as part of an interaction with their customers, with others. There is a need for a system and method for maintaining a dynamic knowledge base.

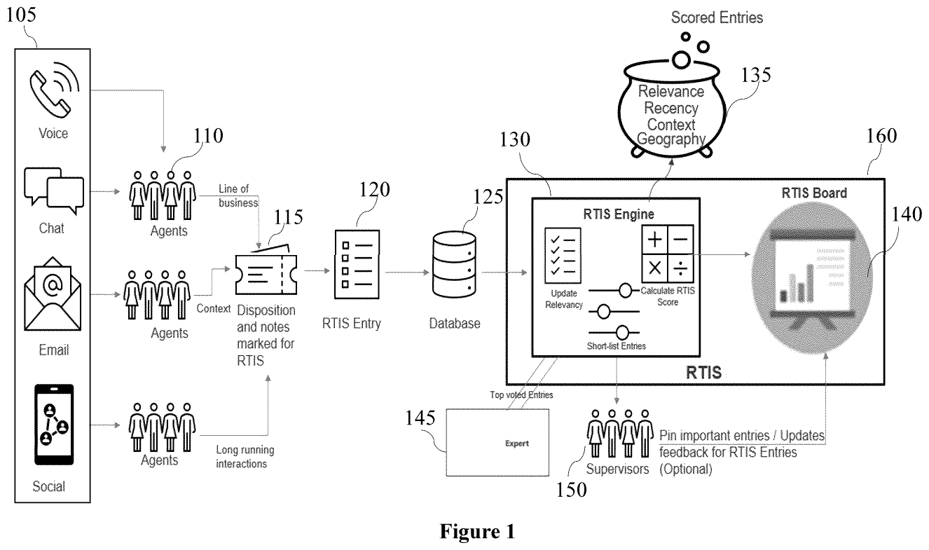

FIG. 1 schematically illustrates a high-level diagram of a Real-Time Information Sharing (RTIS) platform 100 for maintaining a dynamic knowledge base, in accordance with some embodiments of the present invention.

According to some embodiments of the present disclosure, agents 110, in a contact center may communicate with customers to provide service or to resolve an issue via various channels 105, such as voice, chat, email, and social media applications. The resolution to the issues may be temporary and not included in a static knowledge base. For example, a problem adding an item to a cart in an online shop may be resolved by one of the agents by providing the following message to the customer: “Due to high load on the system, the CPU has spiked up. IT team is looking into the issue. The expected resolution time is within two hours. Please try again in two hours and reconnect if there is an issue.” This resolution might be useful to other agents in the contact center at the time that the issue lasts and having it available to them may save time when they provide service to other customers which tackled the same issue.

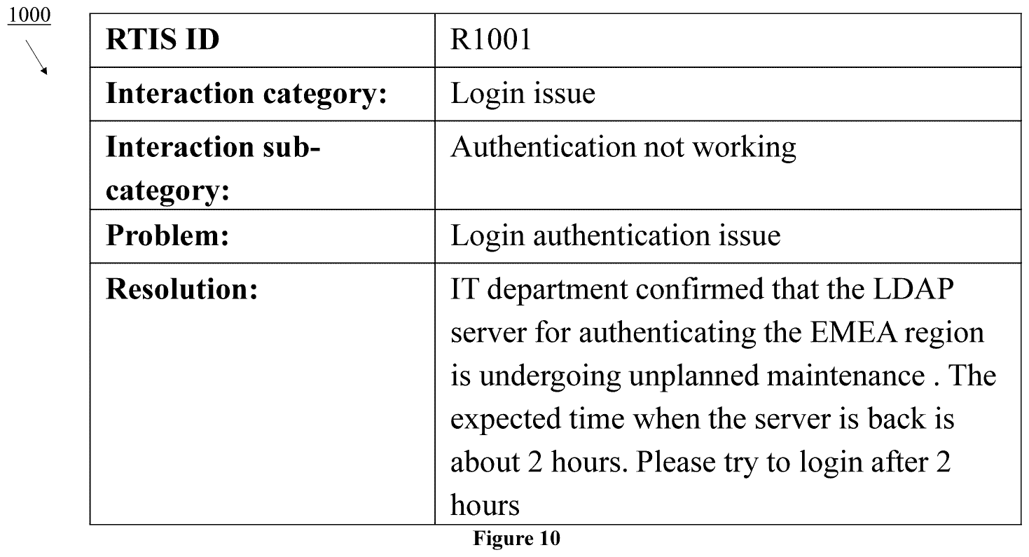

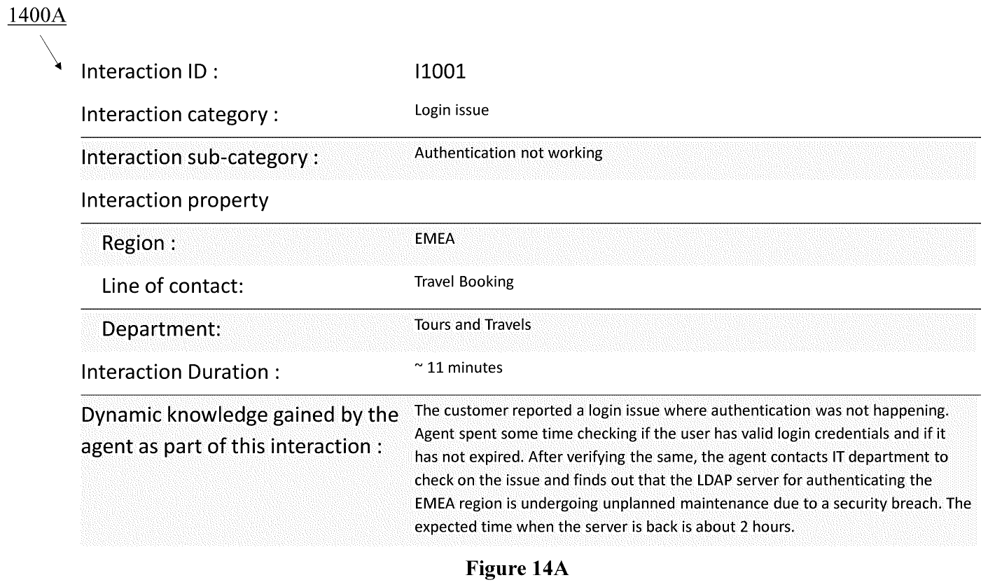

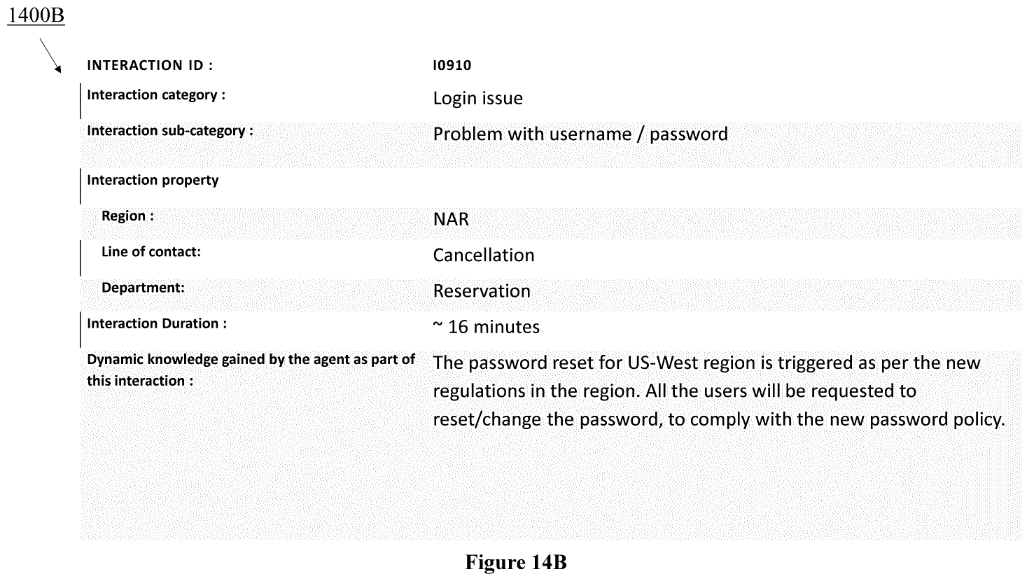

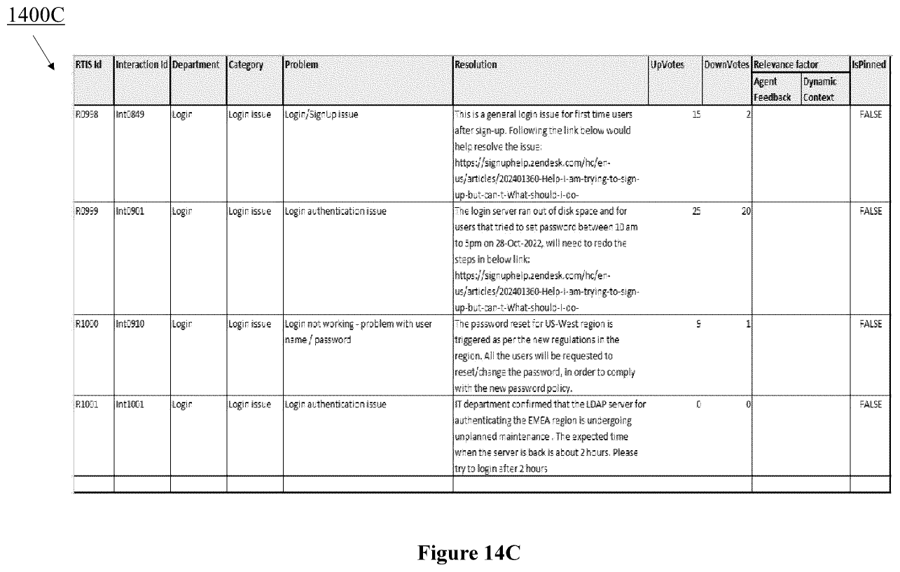

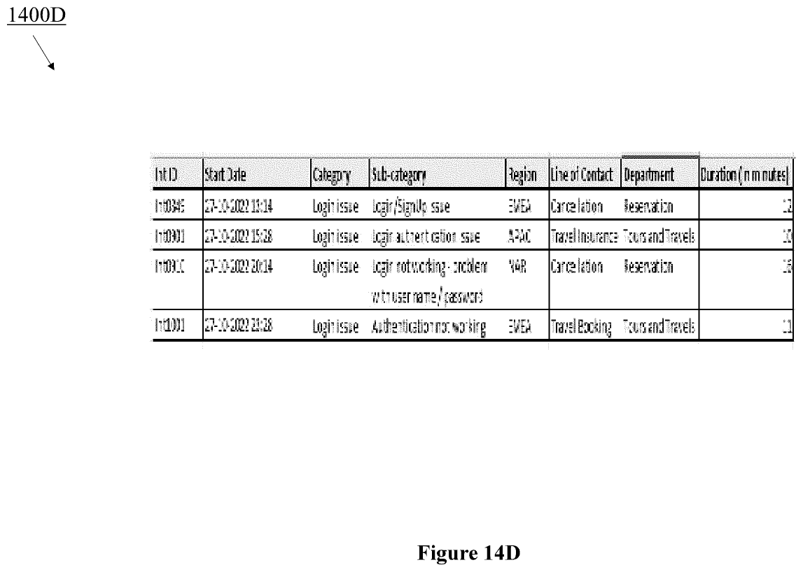

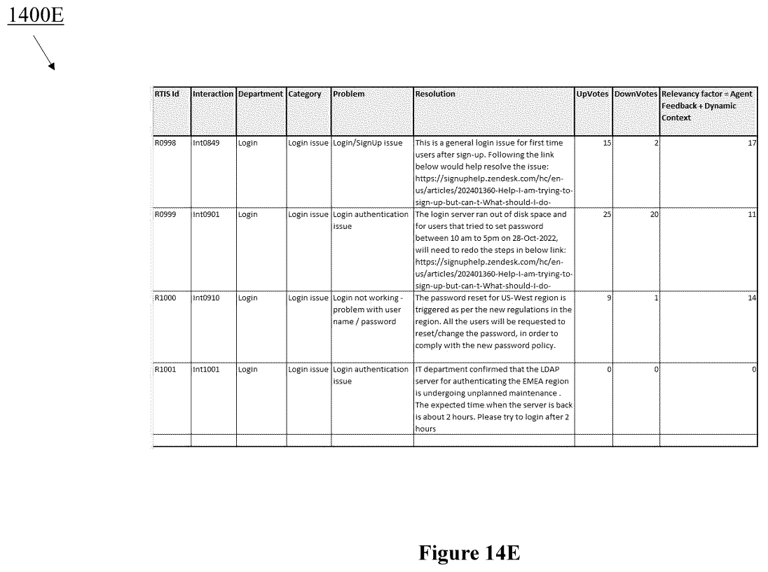

According to some embodiments of the present disclosure, details of the resolution to a customer issue may be written as disposition and notes for a Real-Time Information Sharing (RTIS) entry 120, for example such as RTIS entry 1000 in FIG. 10, and RTIS entries in FIG. 14C.

According to some embodiments of the present disclosure, the RTIS entry 120 may be stored in a database 125 from which the RTIS entries may be retrieved to a Real-Time Information Sharing (RTIS) platform 160 having an RTIS engine 130 and an RTIS board 140.

According to some embodiments of the present disclosure, when an interaction, between an agent and a customer, ends the agent may be presented with an option to convert the details of the interaction to a RTIS entry 120. The details of the interaction may include interaction category, such as login issue, interaction sub-category, such as authentication not working, region, such as Europe, the Middle East and Africa (EMEA), line of contact, such as travel booking, department, such as tours and travels, interaction duration, e.g., 11 minutes and dynamic knowledge gained by the agent during the interaction, e.g., “The customer reported a login issue where authentication was not happening. Agent spent some time checking if the user has valid login credentials and if it has not expired. After verifying the same, the agent contacts IT department to check on the issue and finds out that the LDAP server for authenticating the EMEA region is undergoing unplanned maintenance due to a security breach. The expected time when the server is back is about 2 hours.”, as shown in FIG. 14A. When a user, e.g., an agent decides that the information that has been gained during the interaction may be useful for other users having interactions with the same context in the business day, the interaction may be dispositioned as an RTIS entry 120 by the agent. Then, the RTIS entry 120 may be accepted and stored by the RTIS engine 130.

According to some embodiments of the present disclosure, the RTIS engine 130 may process RTIS entries and score them and then short-list them for a user that is handling an interaction. The RTIS engine 130 may update a relevancy score periodically based on the dynamics of the system and feedback from the agents in the form of upvotes for the RTIS entries which have been used in an interaction.

According to some embodiments of the present disclosure, a supervisor may optionally pin certain RTIS entries for the RTIS board 140 to appear on the top of the list. This may supersede the precedence of the scored RTIS entries. The RTIS engine 130 may also update the relevancy score for entries periodically in a configured time based on system dynamics. The sudden spurt of interactions in a particular line of business with keywords changes the relevancy score of the entries.

According to some embodiments of the present disclosure, the RTIS board 140 may be a panel which may be presented to the user, e.g., agent with short-listed RTIS entries based on recency, relevancy, and line of business. These parameters may be configurable and may be adjusted according to the business environment.

According to some embodiments of the present disclosure, the RTIS platform 160 may include a computer system having one or more processors, a Real-Time Information (RTI) database, such as database 125, a plurality of computerized-devices, each computerized-device of the plurality of computerized devices is associated with a user of a plurality of users, e.g., agents 110. The computer system may be configured to communicate with each computerized-device in the plurality of computerized-devices.

According to some embodiments of the present disclosure, the RTIS 130 may accept, store and process RTIS entries based on recency, relevancy and line of business 135.

According to some embodiments of the present disclosure, the RTIS engine 130 may include: detecting termination of a first interaction of a first user e.g., one of agents 110, to display via a Graphical User Interface (GUI) that is presented on a display unit, an option to mark information as to a resolution to a problem that has been provided during the first interaction for entering the resolution to a RTIS entry 120. Then, upon receiving a marked RTIS entry via the GUI from the first user, storing the marked RTIS entry in the RTI database, such as database 125.

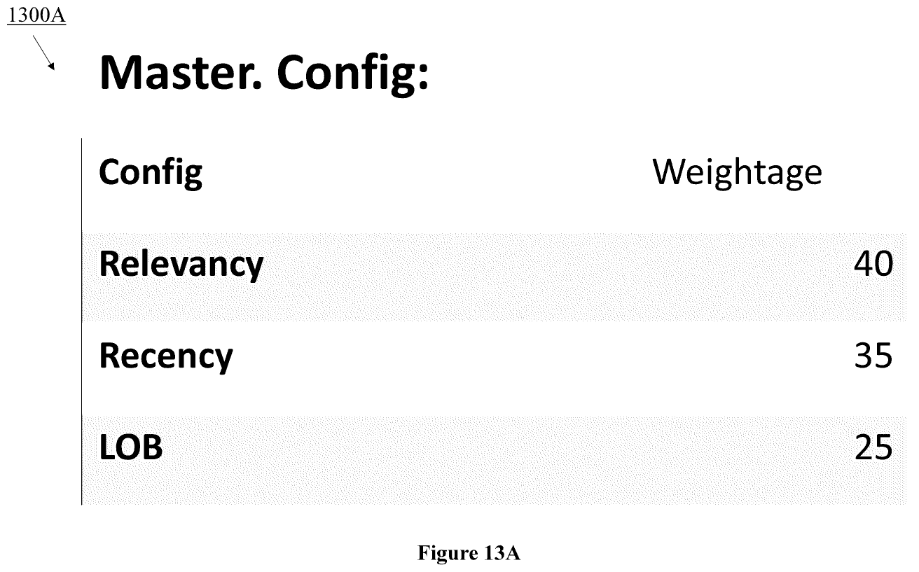

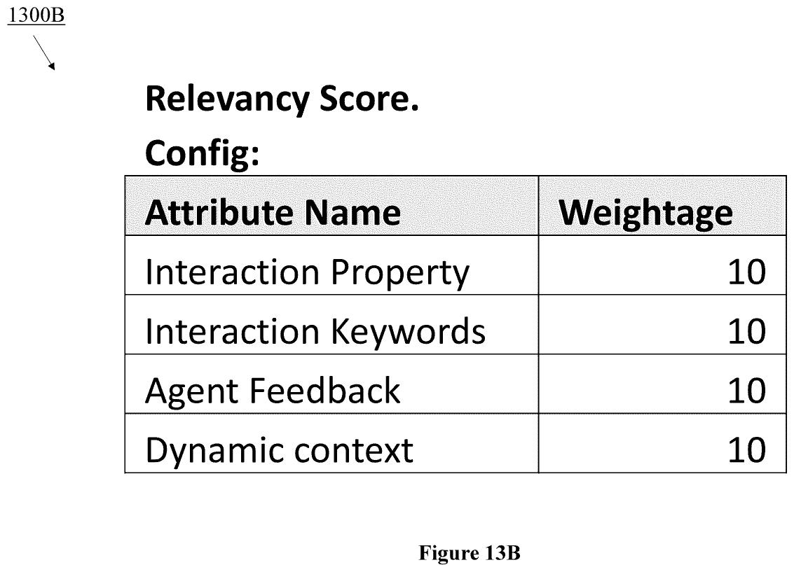

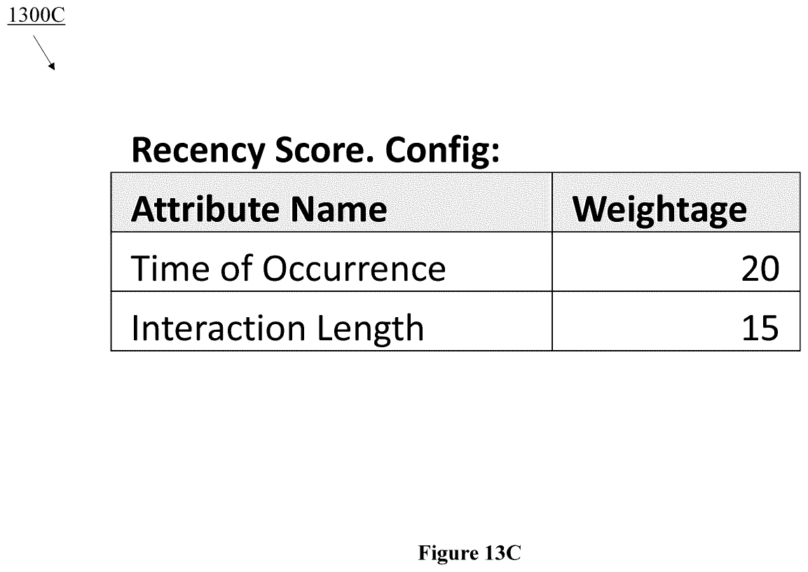

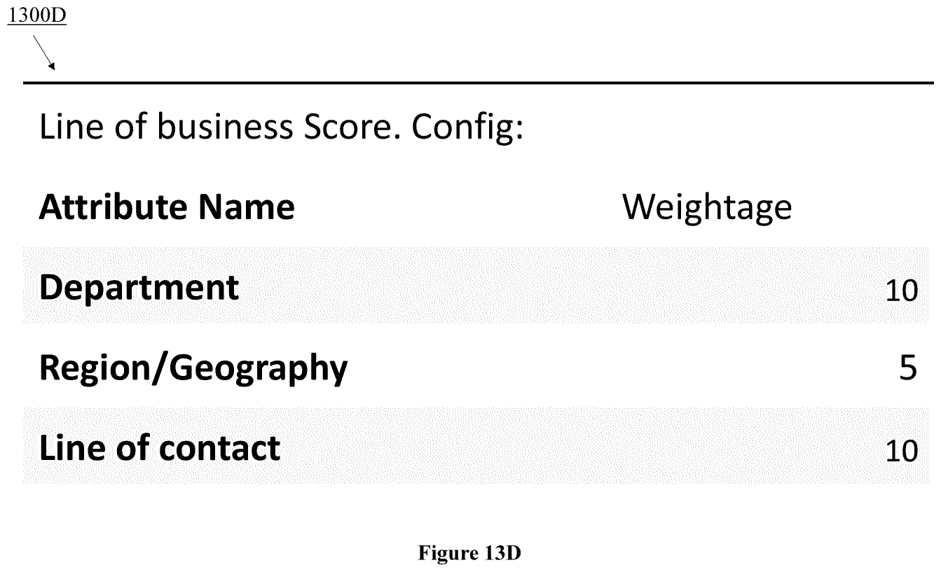

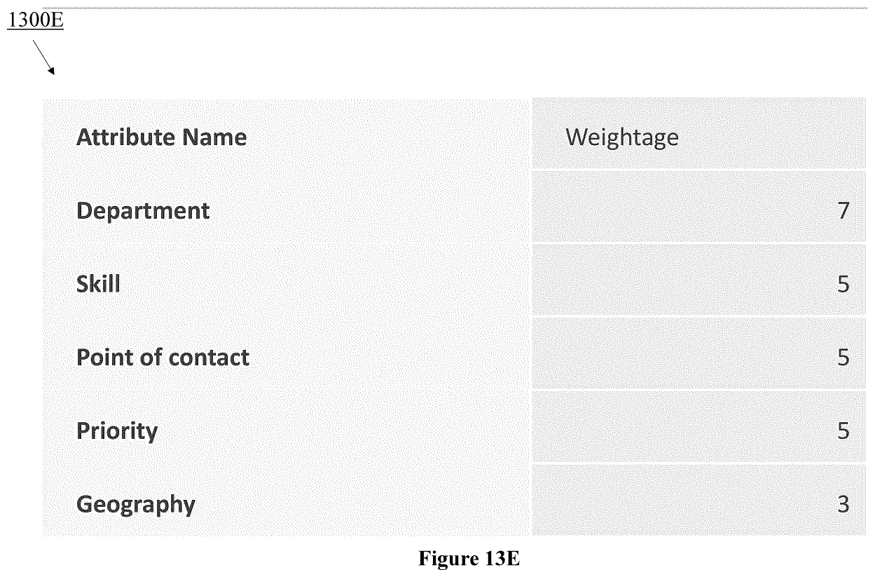

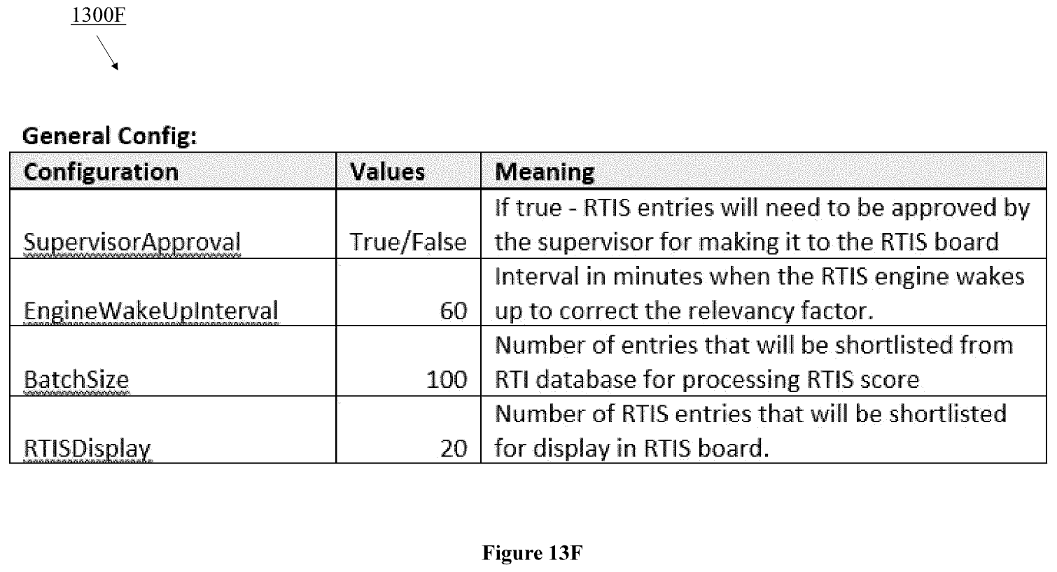

According to some embodiments of the present disclosure, the display unit may be associated to a computerized-device in the plurality of computerized-devices. A batch of RTIS entries may be retrieved from the RTI database, such as database, 125, to calculate a score for each RTIS entry in the batch, based on one or more parameters. The number of RTIS entries in the batch may be configurable and available in master configuration File, for example, general config. file, as shown in FIG. 13F. The one or more parameters may be creation date, subject and line of business. The score may indicate relevance, recency, and line of business of information in the RTIS entry, such as RTIS entry 120. For example, as shown in FIG. 10 and in FIG. 14A.

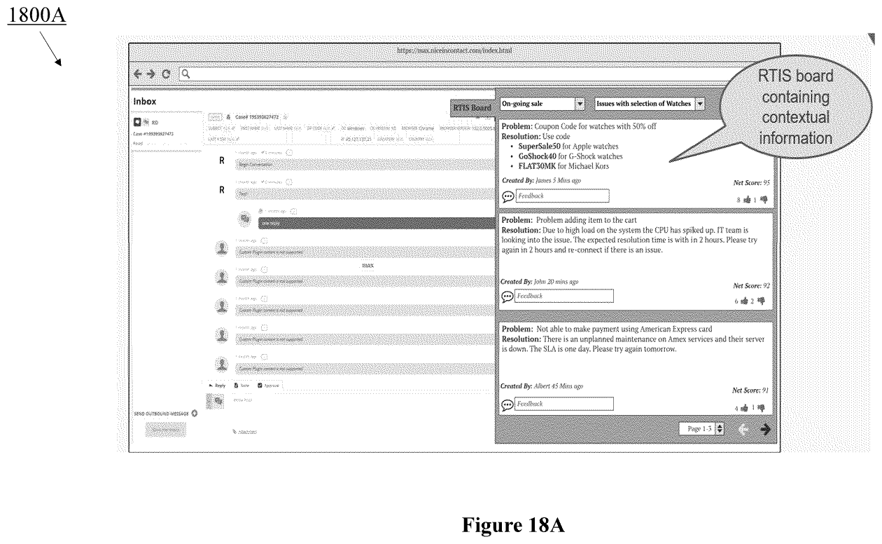

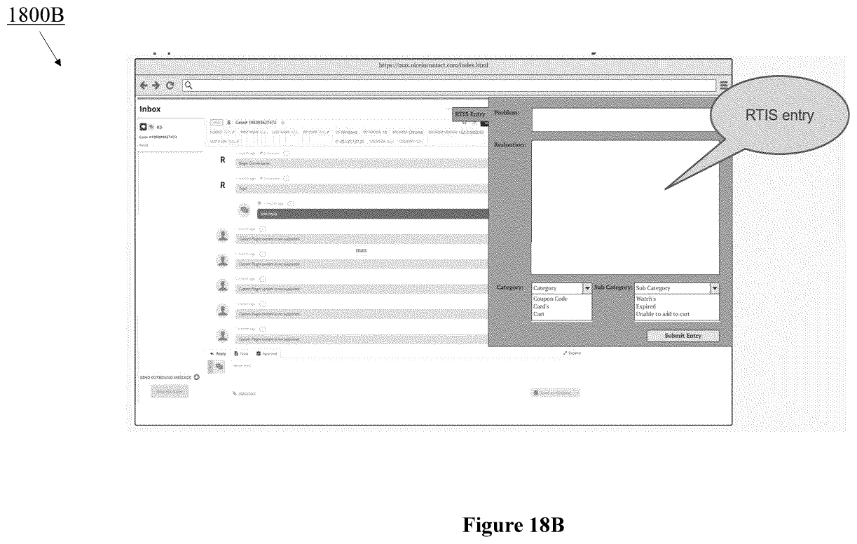

According to some embodiments of the present disclosure, when an interaction starts for an agent, a request may be sent to the RTIS engine 130 for RTIS entries to display for this interaction with the interaction context. A preconfigured number of RTIS entries may be displayed via the GUI, based on the calculated score of the RTIS entries upon receiving a request for display, from a second user, when a second interaction of the second user starts. For example, as shown in FIG. 18A.

According to some embodiments of the present disclosure, the RTIS engine 130 may score the RTIS entries based on interaction context, recency and line of business and short-lists the entries to be presented for a current interaction. The relevance may include agent feedback, dynamic context, interaction category and interaction keywords. The recency score may include the recency of the entry and the duration of the interaction. The line of business may include line of contact, department and region of the interaction.

According to some embodiments of the present disclosure, each RTIS entry 120 may include information that has been provided to a customer during the first interaction. The information may not be included in a static knowledge base.

According to some embodiments of the present disclosure, the RTIS entries may be filtered based on creation date, subject and line of business. The RTIS entries may be displayed from recent date to old date, and the subject and the line of business may be selected by the second user. The displayed RTIS entries may be RTIS entries having highest scores.

According to some embodiments of the present disclosure, the calculating of the score of each entry is performed by formula I:

score=(a) relevance score*weightage1+(b) recency score*weightage2+(c) line-of-business score*weightage3, (I)
whereby:
(a) relevance score may be a sum of: (i) agent feedback score; (ii) dynamic context score, (iii) interaction category score; and (iv) interaction keyword score,
the agent feedback score may be calculated by formula II:

agent feedback score=number of votes/max_votes*agent feedback weightage, (II)
whereby:
number of votes is a number of upvotes subtracted by a number of downvotes,
max_votes is a maximum number of votes from top preconfigured number of RTIS entries, and agent feedback weightage is a configurable weight,
the dynamic context score may be calculated by formula III:

dynamic context score=number of interactions per department/max interactions in a department in the batch*dynamic context weight (III)
interaction category score equals ‘1’ when interaction category of RTIS entry matches interaction category of the second interaction and when interaction category of RTIS entry doesn't match interaction category of the second interaction, interaction category score equals ‘0’,
interaction keyword score may be calculated by formula IV:

interaction keyword score=number of words in the stored RTIS entry which matches a subcategory of the interaction/total number of words in the subcategory of the interaction*interaction keyword weightage, (IV)
the sum of agent feedback weightage, dynamic context weight, recency weightage and interaction keyword weightage equals ‘1’,
(b) the recency score is calculated by summing recency entry score and duration score
whereby:
recency entry score is calculated by formula V:

recency entry score=preconfigured number of recent entries/(recency weightage*100) (V)
duration score is calculated by formula VI:

duration score=duration of interaction of the RTIS entry/maximum duration of interaction in the batch*duration weightage, (VI)
the sum of recency weightage, and duration weightage equals ‘1’,
(c) the line-of-business score is calculated by summing line of contact score*line of contact weightage, department score*department weightage, and region score*region weightage,
whereby:
line of contact score equals ‘1’ when line of contact of RTIS entry matches interaction line of contact of the second interaction and when interaction line of contact of RTIS entry doesn't match interaction line of contact of the second interaction line of contact score equals ‘0’,
department score equals ‘1’ when department of RTIS entry matches department of the second interaction and when department of RTIS entry doesn't match department of the second interaction department score, equals ‘0’, and
region score equals ‘1’ when region of RTIS entry matches region of the second interaction and when region of RTIS entry doesn't match region of the second interaction, region score equals ‘0’, and the sum of line of contact weightage, department weightage and region weightage equals ‘1’. The sum of weightage1, weightage2 and weightage 3 equals ‘1’.

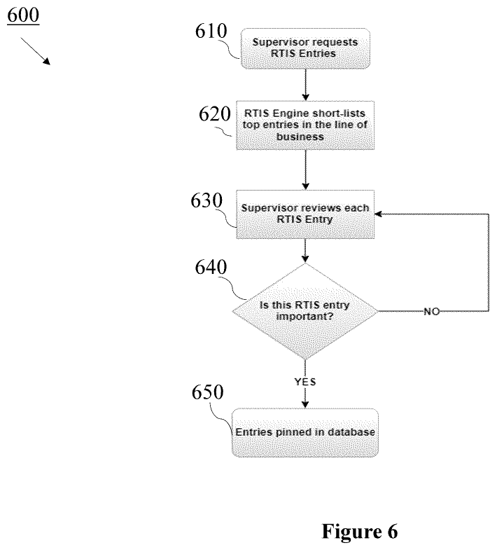

According to some embodiments of the present disclosure, the RTIS engine 130 may further include displaying via the GUI, that is presented on a display unit, an option to pin RTIS entries to be included in the preconfigured number of RTIS entries regardless of the score of the RTIS entry, as shown in FIG. 6.

According to some embodiments of the present disclosure, the RTIS engine 130 may further include updating the relevance score of the RTIS entries every preconfigured time.

According to some embodiments of the present disclosure, the option to mark information provided during the interaction for conversion to a RTIS entry may be displayed based on duration of the interaction and context thereof.

According to some embodiments of the present disclosure, the RTIS engine 130 may further include receiving a supervisor approval before the receiving of the RTIS entry 120 via the GUI from the first user, e.g., an agent in a contact center.

According to some embodiments of the present disclosure, the RTIS engine 130 may further include enabling feedback from the users by providing a user an option to vote up or vote down, via the GUI, for each displayed RTIS entry, after reviewing it, as shown in FIG. 18A. The relevancy score of an RTIS entry may be updated by the RTIS engine 130 based on the feedback from the agents on how useful the information was, for a problem resolution.

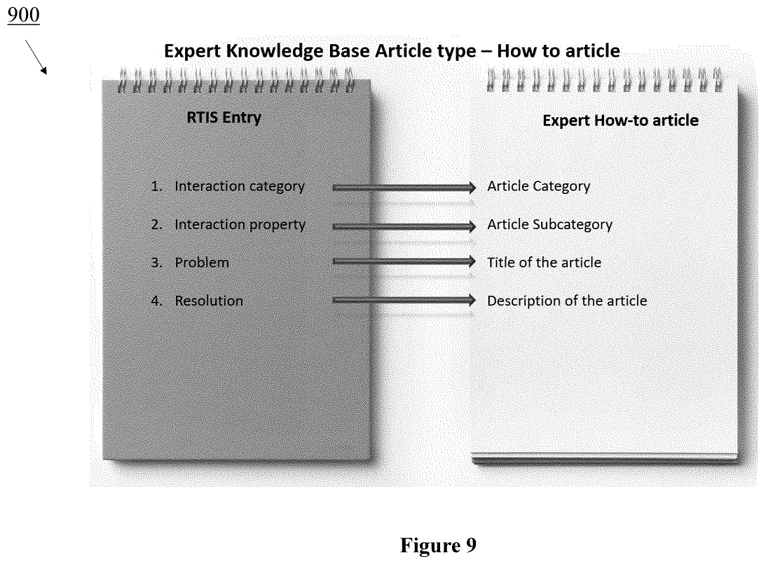

According to some embodiments of the present disclosure, the RTIS engine 130 may further include checking every preconfigured time-interval the calculated score of RTIS entries which were received in last preconfigured time-interval to determine a preconfigured percentage of the RTIS entries that have the highest score. The determined preconfigured percentage of the RTIS entries may be sent to an invoked expert Application Programming Interface (API) for creating a how-to article from the determined RTIS entries, for example, as shown in FIG. 9.

According to some embodiments of the present disclosure, the most up-voted RTIS entries may be converted automatically to a knowledge base article and may be helpful in coaching the agents in future, when similar problems arise. A static knowledge base of articles where useful problem resolutions and knowledge out of interactions are gathered and formally documented.

According to some embodiments of the present disclosure, the frequently used RTIS entries may be formalized as Frequently Asked Question (FAQ)s by the RTIS engine 130 periodically, which may be available for agents to increase their dynamic knowledge. Thus, agents may handle more interactions in a better and faster way and may increase their scenario readiness.

According to some embodiments of the present disclosure, by presenting users such as agents with real-time contextual information as scored RTIS entries, improving the dynamic knowledge shared between users, such as agents 110. This dynamic knowledge may be handy in a rapidly changing business environment by enabling cross-agent sharing of information.

According to some embodiments of the present disclosure, the RTIS platform 160 may improve agent efficiency by providing real-time assistance to develop a dynamic knowledge required to guide a user, such as an agent in a customer interaction through frictionless first-time resolutions in less time, thus improving the overall customer experience.

According to some embodiments of the present disclosure, top voted RTIS entries may be retrieved by a user such as an expert 145.

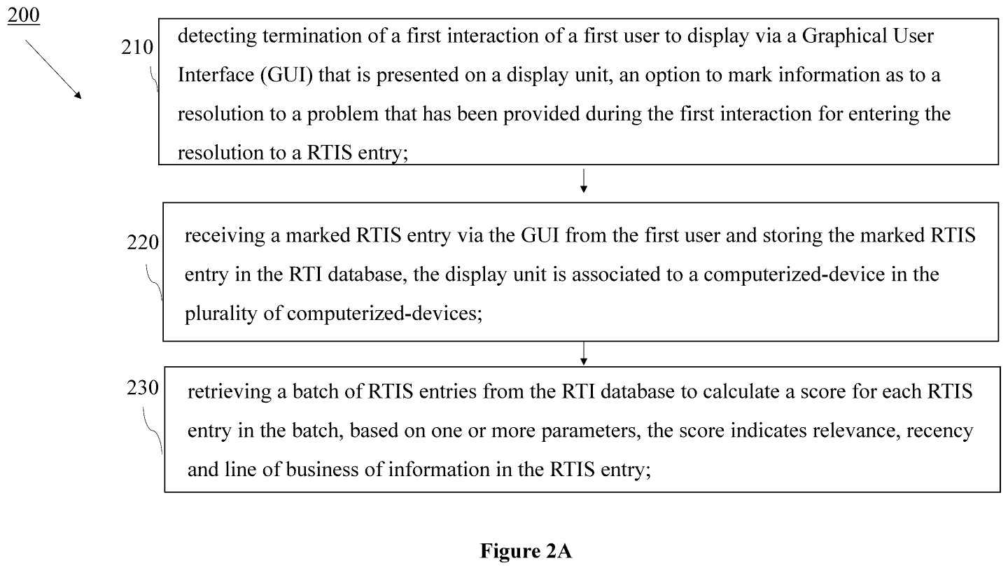

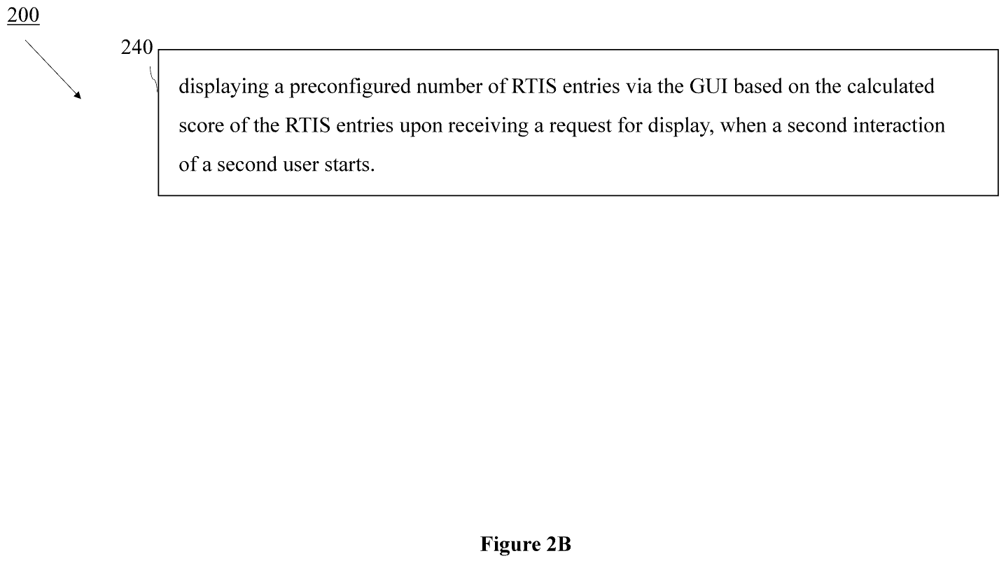

FIGS. 2A-2B is a high-level workflow of operations for maintaining a dynamic knowledge base via a Real-Time Information Sharing (RTIS) platform, in accordance with some embodiments of the present invention;

According to some embodiments of the present disclosure, operation 210 comprising detecting termination of a first interaction of a first user to display via a Graphical User Interface (GUI) that is presented on a display unit, an option to mark information as to a resolution to a problem that has been provided during the first interaction for entering the resolution to a RTIS entry. The RTIS entry may be an entry such as RTIS entry 120 in FIG. 1 e.g., such as RTIS entry 1000A in FIG. 10.

According to some embodiments of the present disclosure, operation 220 comprising receiving a marked RTIS entry via the GUI from the first user and storing the marked RTIS entry in the RTI database, the display unit is associated to a computerized-device in the plurality of computerized-devices.

According to some embodiments of the present disclosure, operation 230 comprising retrieving a batch of RTIS entries from the RTI database to calculate a score for each RTIS entry in the batch, based on one or more parameters, the score indicates relevance, recency and line of business of information in the RTIS entry.

According to some embodiments of the present disclosure, displaying a preconfigured number of RTIS entries via the GUI based on the calculated score of the RTIS entries upon receiving a request for display, when a second interaction of a second user starts. For example, as shown in screenshot 1800A in FIG. 18A.

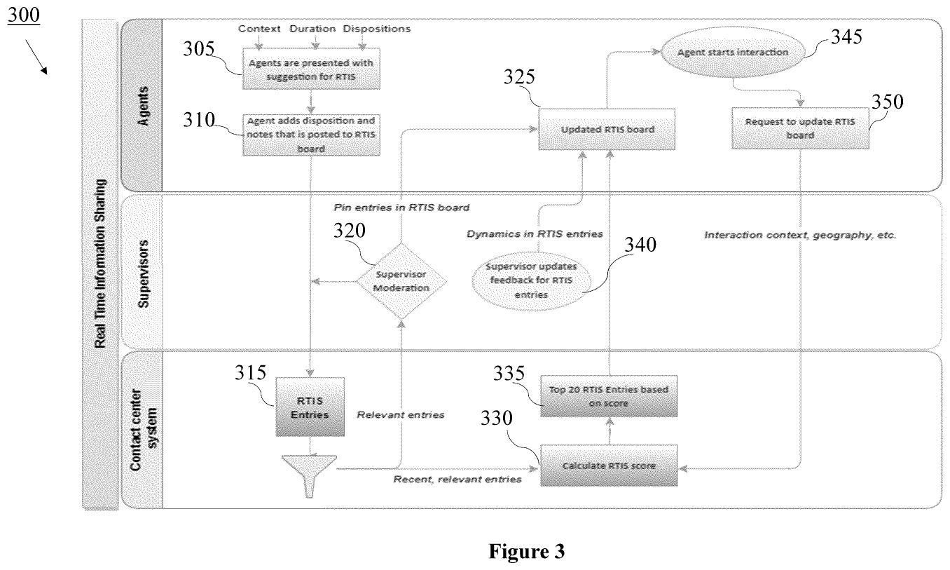

FIG. 3 schematically illustrates a high-level workflow 300 of the information within the RTIS platform, in accordance with some embodiments of the present invention.

According to some embodiments of the present disclosure, creation of an RTIS entry, such as RTIS entry 120 in FIG. 1, occurs when an interaction ends based on context and duration of the interaction. The RTIS entry may be moderated by the supervisor on demand. The entries may also have the relevancy score updated automatically by an engine, such as the RTIS engine 130 in FIG. 1, in configured intervals. The RTIS entries may be available for display to the agents when a new interaction starts. Upon RTIS entries pinned by a user, such as a supervisor, the RTIS entries may be short-listed and presented to the agents in a board, such as RTIS board 140 in FIG. 1.

According to some embodiments of the present disclosure, agents may be presented with suggestion for RTIS 305, i.e., a suggestion to convert an interaction to RTIS entry based on context, duration and the disposition that the agent selects when ending the interaction so the agent may add disposition and notes that is posted to RTIS board 310. The RTIS board may be updated when an interaction starts with short-listed entries. The RTIS board may be a board, such as RTIS board 140 in FIG. 1.

According to some embodiments of the present disclosure, the RTIS entries may be filtered 315 and forwarded for supervisor moderation 320 to pin RTIS entries in the RTIS board as well as for calculating RTIS score 330 based on recent, relevant entries. The pinned entries may be displayed in the top of the RTIS entry list in the RTIS board.

According to some embodiments of the present disclosure, top preconfigured number of RTIS entries based on score, for example, top 20 RTIS entries based on score 335 may be forwarded to updated RTIS board 325 as well as supervisor updates feedback for RTIS entries 340 and pin entries as a result of supervisor moderation 320.

According to some embodiments of the present disclosure, the updated RTIS board 325 by the pinned entries from supervisor moderation 320 and supervisor updates feedback 340 and top preconfigured number of RTIS entries based on score 335, may be forwarded to be displayed via the GUI based on the calculated score of the RTIS entries upon receiving a request for display, when an agent starts an interaction 345. The RTIS entries may be short-listed and displayed when an interaction starts.

According to some embodiments of the present disclosure, after the agent starts the interaction, the agent may request to update the RTIS board 350 and then the RTIS engine, such as RTIS engine 130 in FIG. 1, may calculate RTIS score 330 for all RTIS entries.

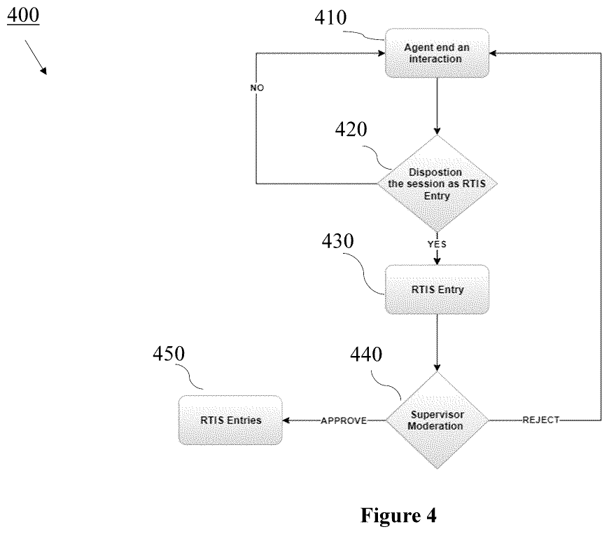

FIG. 4 schematically illustrates a high-level workflow 400 for an RTIS entry, in accordance with some embodiments of the present invention.

According to some embodiments of the present disclosure, when agent ends an interaction 410, the agent may be presented with a suggestion to disposition the session as an RTIS entry 420 based on context and interaction duration. If an agent feels the suggestion is relevant, the agent can then disposition the interaction with problem and resolution and submit it as an RTIS entry 430. This RTIS entry is then saved in the database, such as database 125, in FIG. 1, based on the approval from supervisor. The RTIS entry may be further processed by the RTIS engine, such as RTIS engine 130 in FIG. 1. Supervisor moderation 440, i.e., the approval by the supervisor may be optional and may be disabled in the configuration. When the RTIS entries 450 are approved by the supervisor it may be stored in the RTI database and later on presented on a RTIS board for new interactions the agent starts. When the supervisor rejects the RTIS entry may not be stored in the RTI database.

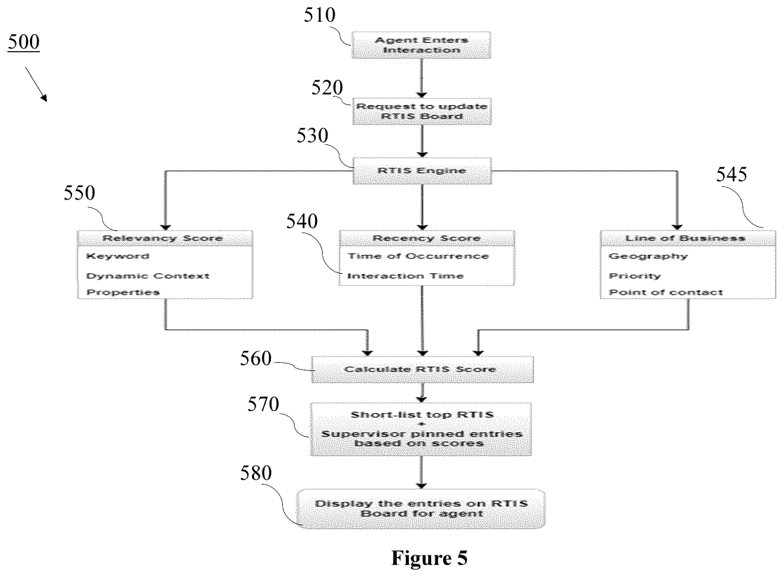

FIG. 5 schematically illustrates a high-level workflow 500 for displaying RTIS entries to agents, in accordance with some embodiments of the present invention.

According to some embodiments of the present disclosure, when an agent enters an interaction 510, a request may be sent to update the RTIS board 520 for RTIS entries by sending the interaction context like property, keyword, department, priority, etc. to the RTIS engine 530. Based on the match with relevancy score 550, e.g., keyword, dynamic context and properties, recency score 540, e.g., time of occurrence and interaction time and line of business 545, e.g., geography, priority and point of contact, the RTIS engine such as RTIS engine 130 in FIG. 1, may score, i.e., calculate RTIS score 560 and short list top RTIS supervisor pinned entries based on scores 570 and then return the RTIS entries to the agent for display on the RTIS board 580 for the ongoing interaction.

According to some embodiments of the present disclosure, the agent may provide feedback to the RTIS engine by voting the entries presented to the agent, as shown in screenshot 1800A in FIG. 18A. Agent can up or down vote the RTIS entries. Based on the number of up or down votes, the relevancy score for that RTIS entry may be updated which serves as a loop back variable for the RTIS engine to self-correct the relevancy score of the RTIS entry.

FIG. 6 schematically illustrates a high-level workflow 600 for pinning most relevant and recent RTIS entries in the database, in accordance with some embodiments of the present invention.

According to some embodiments of the present disclosure, the supervisor also can request for the most relevant and recent RTIS entries in their departments, review and pin them occasionally based on business demands. The pinned entries supersede the other entries and may be shortlisted for display in a RTIS board for agents in that department.

According to some embodiments of the present disclosure, the supervisor requests RTIS entries 610, the RTIS engine, such as RTIS engine 130 in FIG. 1, short-lists top entries in the line of business 620. Then the supervisor reviews each RTIS entry 630 to check is this RTIS entry important 640, if it is important then the entries may be pinned in the database 650 such as database 125 in FIG. 1. Otherwise, if the RTIS entry is not important then it may be available in the RTI database and may be short-listed based on the calculated RTIS score.

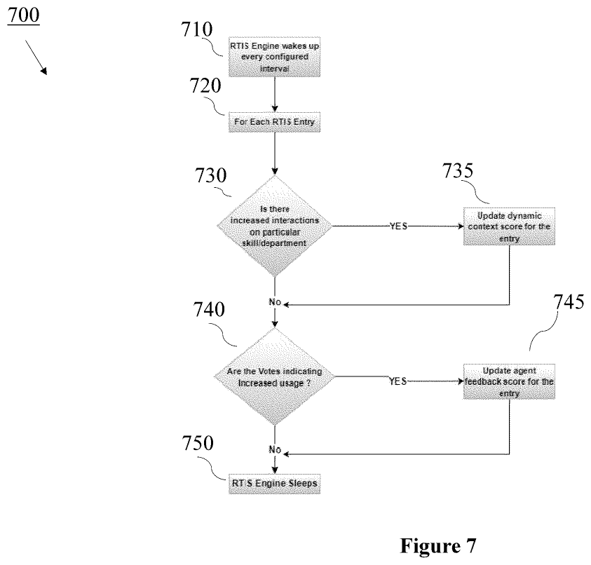

FIG. 7 schematically illustrates a high-level workflow 700 for relevancy score adjustment by the RTIS engine, in accordance with some embodiments of the present invention.

According to some embodiments of the present disclosure, the RTIS engine wakes up every configured interval 710, the RTIS engine, such as RTIS 130 in FIG. 1, may run periodically in the configured interval to update the relevancy score for each RTIS entry 720, based on the business dynamics and feedback from agents. Thus, a self-learning mechanism is implemented in the RTIS engine to present the agents with the most meaningful suggestions for guidance during an interaction. When there is an increase in interactions volume in a particular skill or department or point of contact, the relevancy score for the RTIS entries belonging to these categories are adjusted accordingly. Also, based on the up votes or down votes on the RTIS entry, the relevancy score may be readjusted.

According to some embodiments of the present disclosure, the relevancy score may be adjusted based on dynamics of the system. The RTIS engine, may check at configured intervals, the volume of interaction in each department or skill, is there increased interactions on particular skill or department 730 based on the percentage increase in number of interactions within the department or skill, the RTIS entries may be mapped to those departments are adjusted their relevancy score, i.e., update relevancy score for the entry 735. For example, if there is a sudden increase in login issues by 60% over the last one hour, then the relevancy score for dynamic feedback, for the RTIS entries belonging to the login department is also updated to 60% of the weighted score. If there is no increase in interactions, then the RTIS engine may move to the next check.

According to some embodiments of the present disclosure, the relevancy score may be adjusted based on agent feedback or usefulness. The RTIS engine, may check at configured intervals, the number of up votes for a particular RTIS entry. Are the votes indicating increased usage? 740, i.e., based on the percentage increase in number of upvotes and downvotes for that RTIS entry, the RTIS engine may adjust its relevancy score as configured for agent feedback, i.e., update relevancy score for the entry 745. For example, if a particular RTIS entry is upvoted 10 times between the last interval and now and down-voted twice, then the relevancy score for the RTIS entry may be increased by 80% based on the agent feedback weightage.

According to some embodiments of the present disclosure, otherwise, if there is no increase in votes, the RTIS engine sleeps 750.

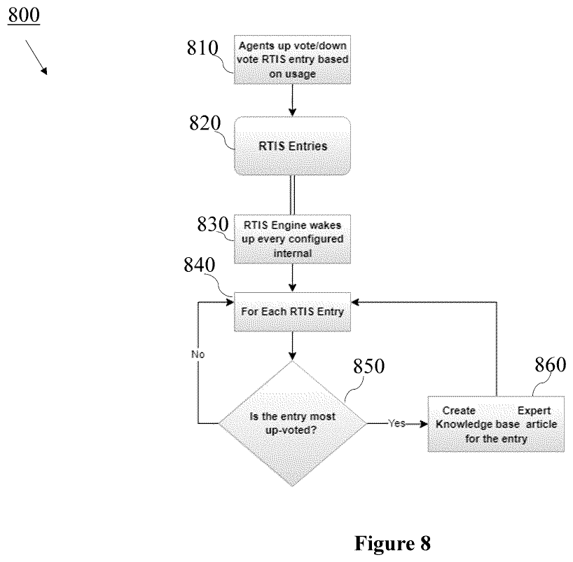

FIG. 8 schematically illustrates a high-level workflow 800 of a process of feedback loop of agents, in accordance with some embodiments of the present invention.

According to some embodiments of the present disclosure, the agents may up or down vote the RTIS entries based on usage 810, i.e., the usefulness of the RTIS entry. The number of votes for each RTIS entry of the RTIS entries 820, may be stored in the database, such as database 125 in FIG. 1, which may be used to create expert articles, as shown in FIG. 9. The RTIS engine wakes up once every configured interval 830 and works up on the RTIS entries with highest up-votes, is the entry most up-voted 850 and creates expert knowledge base article for the entry 860, which serves as a guide in the future for the agents handling similar problems.

FIG. 9 is an example 900 of expert knowledge base article type, in accordance with some embodiments of the present invention.

According to some embodiments of the present disclosure, the RTIS engine, such as RTIS engine 130 in FIG. 1 may check every preconfigured interval, default 24 hours, on the votes of the RTIS entries that occurred between the last interval and current time. The RTIS engine may select a preconfigured percentage, default 10% of these RTIS entries and creates them as expert knowledge base article. For example, Expert API for creating a how-to article is invoked with the following parameters and a knowledge base article is created with the same.

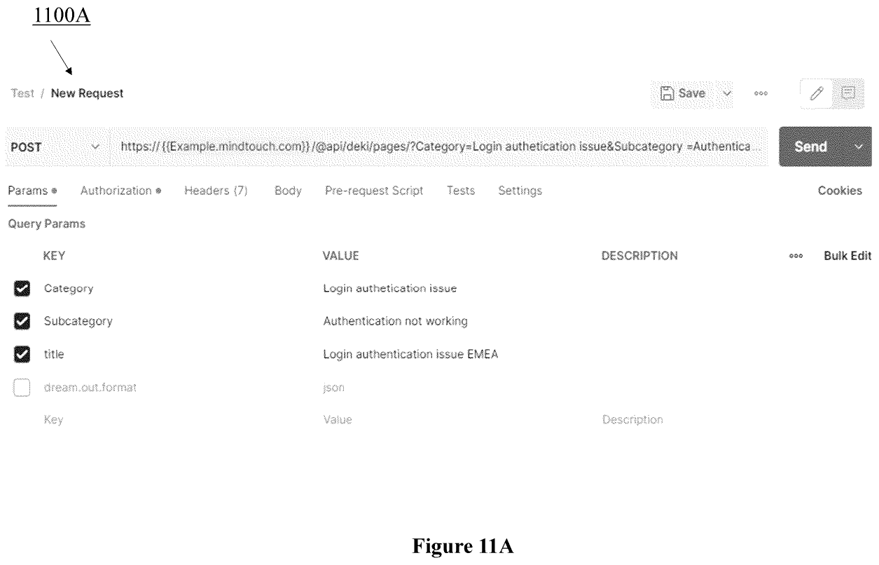

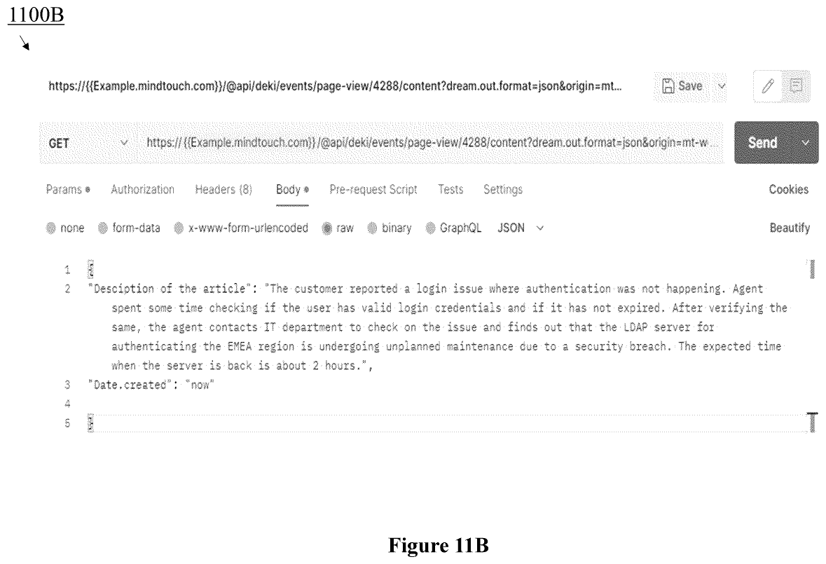

FIGS. 11A-11B are an example of two consecutive API calls for creating an article in Expert knowledge base, in accordance with some embodiments of the present invention.

According to some embodiments of the present disclosure, for an RTIS entry, such as RTIS entry 1000 in FIG. 10 two consecutive API calls for creating an article in Expert knowledge may be creating page with category, subcategory and title with POST API call, such as element 1100A in FIG. 11A and the consecutive call to the page with the page id returned from the previous call, together with content being the problem resolution to the article may be for example such as element 1100B in FIG. 11B.

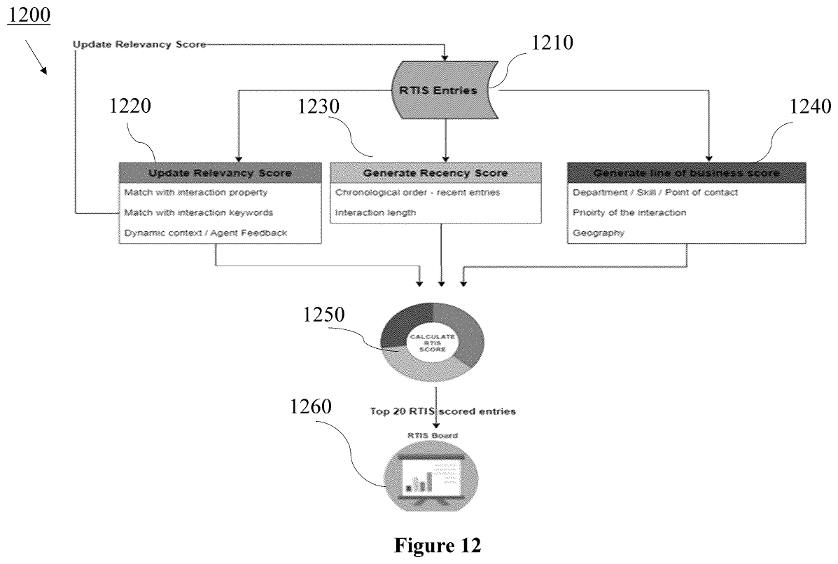

FIG. 12 a high-level workflow 1200 of RTIS score calculation, in accordance with some embodiments of the present invention.

According to some embodiments of the present disclosure, the RTIS score may be calculated based on three scores: relevancy, recency and line of business, as shown in formula I.

According to some embodiments of the present disclosure, as to the relevancy score, update the relevancy score 1220, the RTIS entries may be updated with a static relevancy score which gets updated by the RTIS engine, such as RTIS engine 130 in FIG. 1, in a configured interval based on the dynamics of the system and the feedback loop from the agent. In addition to this static relevancy score, there is also a dynamic relevancy score which is calculated on weighted score based on match with interaction properties or categories and keywords associated with the interaction.

According to some embodiments of the present disclosure, as to the recency, the recency score 1230 of an RTIS entry is based on the chronological ordering of the RTIS entry, the most recent entry gets a higher score for recency and also based on the length of the interaction. The lengthier the interaction, the higher the recency score.

According to some embodiments of the present disclosure, as to the line of business score, the line of business score 1240 may be based on the match with the department, skill, point of contact, priority, geography and other configurable parameters that are associated with the interaction. The more the number of matches, the higher is the line of business score. The RTIS entry score 1250 may be based on a cumulative score of the three scores above, in a configurable manner.

According to some embodiments of the present disclosure, the top preconfigured RTIS scored entries, e.g., top 20 RTIS scored entries may be forwarded to a RTIS board 1260, such as RTIS board 140 in FIG. 1.

FIGS. 13A-13G are examples of configuration files used in RTIS score calculation, in accordance with some embodiments of the present invention.

According to some embodiments of the present disclosure, the weightage for each element in formulae I-VI may be configurable. FIG. 13E is an example of config file for line of business score.

According to some embodiments of the present disclosure, optionally, the configuration files 1300A-1300G may be modified to add or edit interaction attributes that may be needed for modifying the scores according to business needs or requirements.

FIG. 14C is an example of an RTIS entry table, in accordance with some embodiments of the present invention.

According to some embodiments of the present disclosure, after an addition of interaction 1400A as a RTIS entry and having an interaction 1400B as a RTIS entry 1400B, a table of RTIS entries 1400C may include several RTIS entries. Table 1400C does not include updated relevance score as in table 1400E in FIG. 14E.

FIG. 14D is an example of interaction context, in accordance with some embodiments of the present invention.

According to some embodiments of the present disclosure, the RTIS engine, such as RTIS engine 130 in FIG. 1, may calculate the relevance score for entries in the interaction context table 1400D which may result in table 1400E in FIG. 14E, which is an example of relevance score for each RTIS entry, in accordance with some embodiments of the present invention.

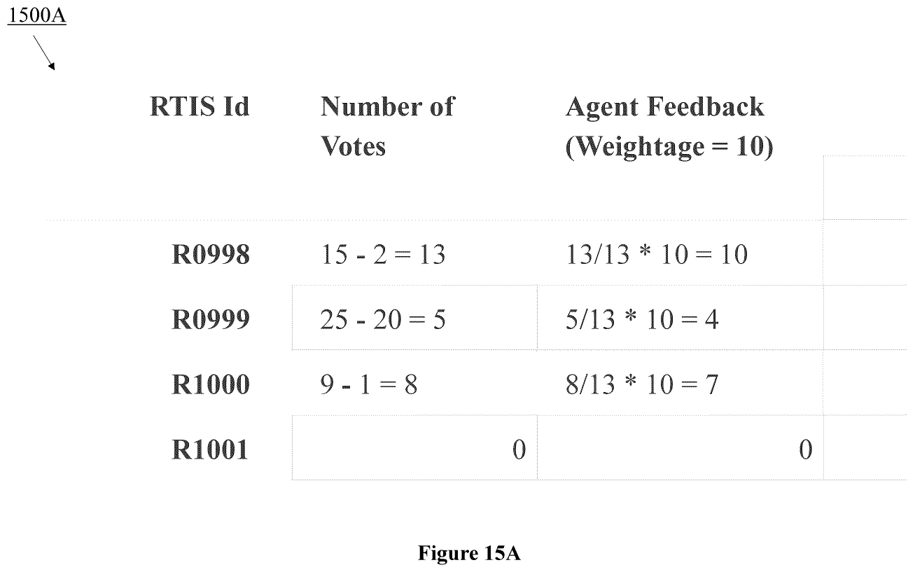

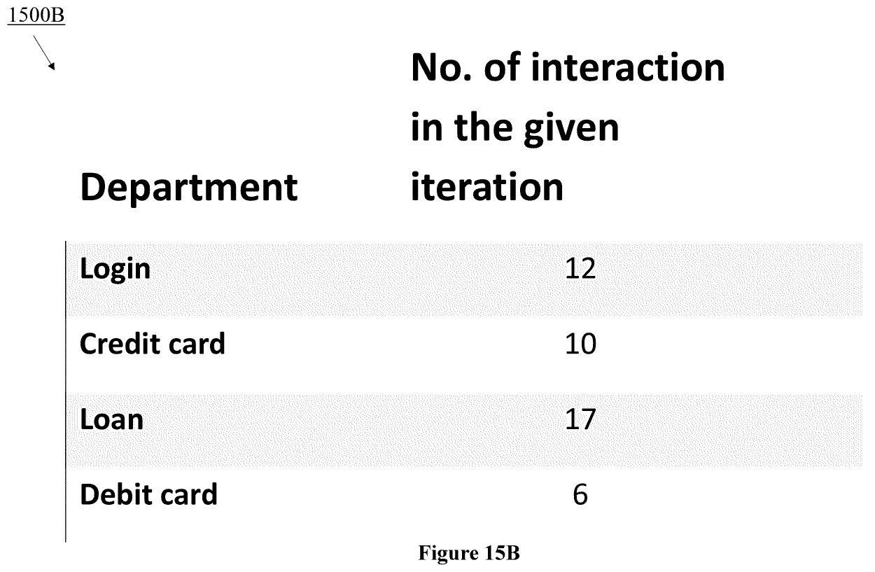

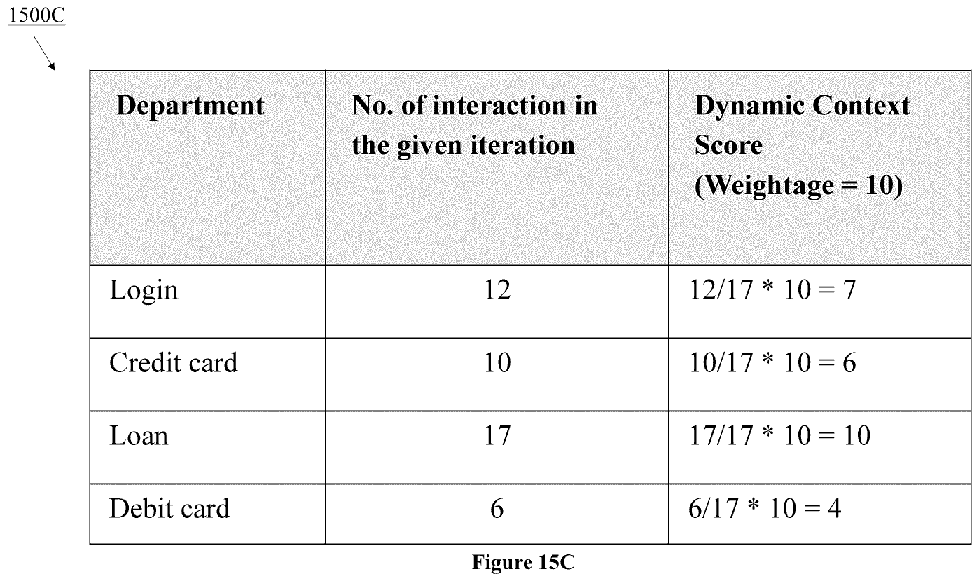

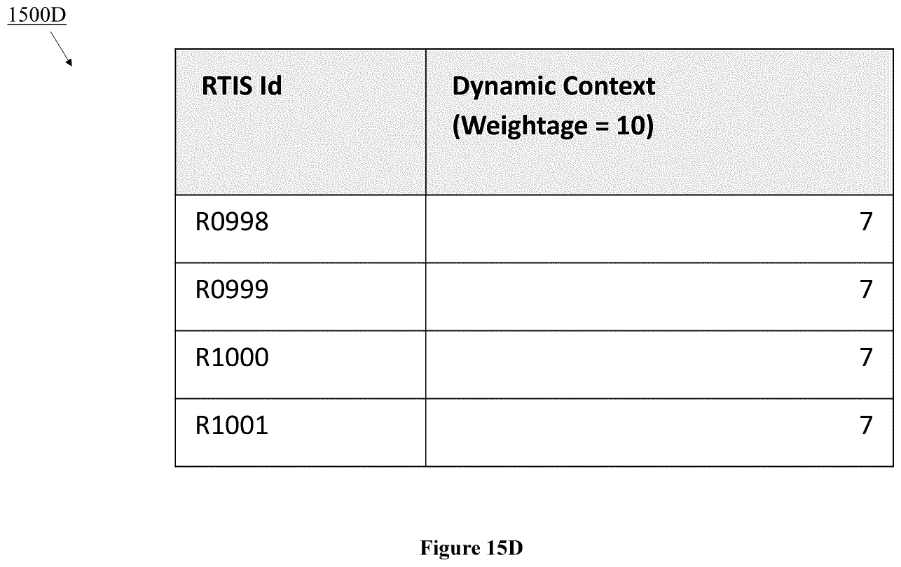

FIG. 15A is an example 1500A of agent feedback score calculation, in accordance with some embodiments of the present invention.

According to some embodiments of the present disclosure, the agent feedback score calculation may be based on a difference between upvotes and downvotes. number of votes=# of upvotes−# of downvotes. The max votes may be equal to a maximum number of votes from the preconfigured number of RTIS entries. For each RTIS entry, the agent feedback score may be calculated by formula II:

Agent feedback score=Number of Votes/Max Votes*Agent Feedback weightage.
In example 1500A, the max number of votes is 13 and the number of votes and agent feedback score is 13,10 for RTIS ID ‘R0998’, 5,4 for RTIS ID ‘R0999’, 8,7 for RTIS ID ‘R1000’ and 0,0 for RTIS ID ‘R1001’.

FIG. 15B is an example 1500B of number of interactions in each department, in accordance with some embodiments of the present invention.

According to some embodiments of the present disclosure, max interactions for the top entries is 17, such that for example, for Loan department and the dynamic context score may be 10.

FIG. 15C is an example 1500C of dynamic context score calculation, in accordance with some embodiments of the present invention.

According to some embodiments of the present disclosure, the dynamic context score may be calculated by formula III. The dynamic context score may equal the number of interactions per department/max interactions*dynamic context weightage. The number of interactions per department may be the total number of interactions grouped by department from top preconfigured entries, e.g., top 100 entries and the max interactions may be maximum number of interactions across all departments for each department. For example, Login 12, credit card 10, Loan 17 and debit card 6.

FIG. 15D is an example of RTIS entries of login department and the dynamic context score, in accordance with some embodiments of the present invention.

According to some embodiments of the present disclosure, since in the example, the RTIS entries are from login department, the dynamic context score would be 7.

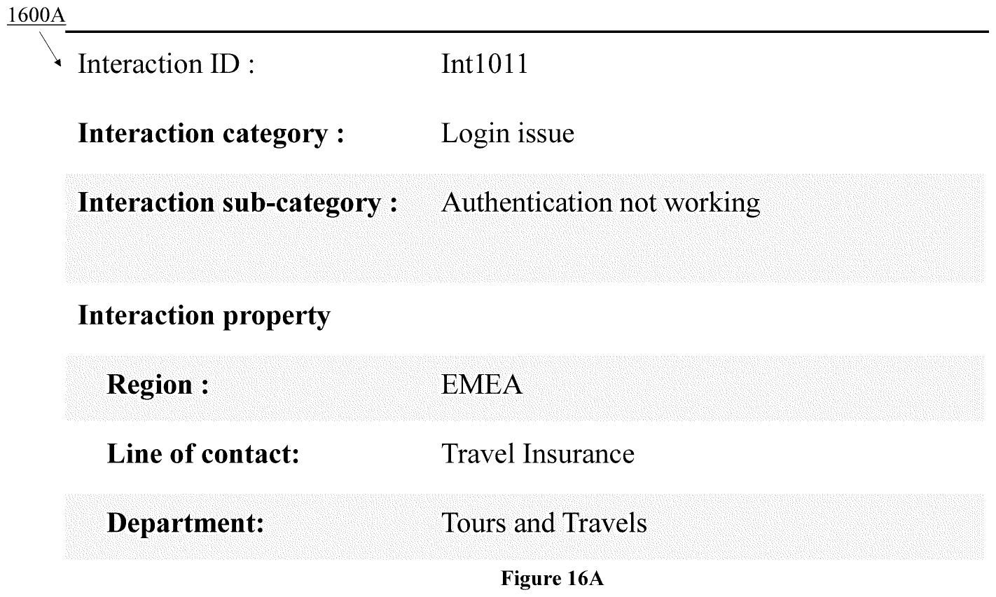

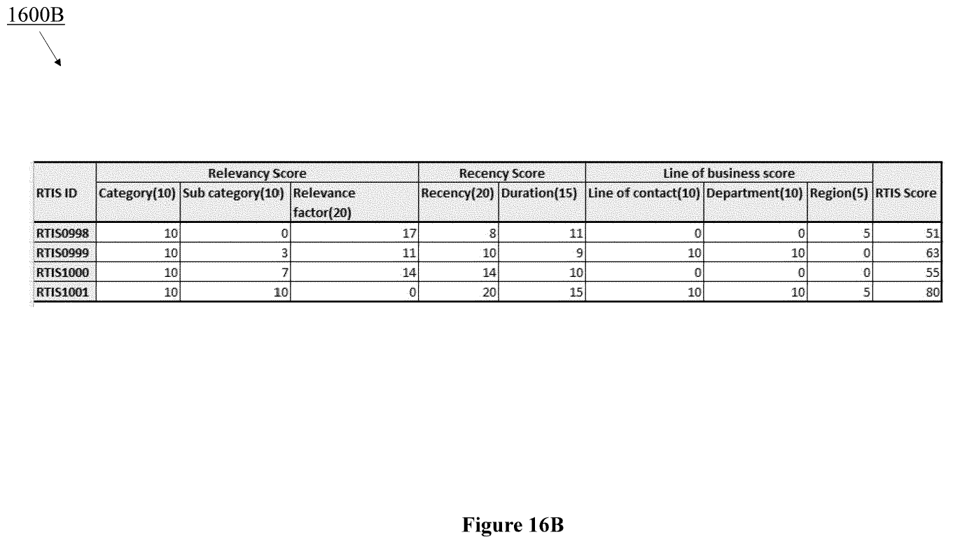

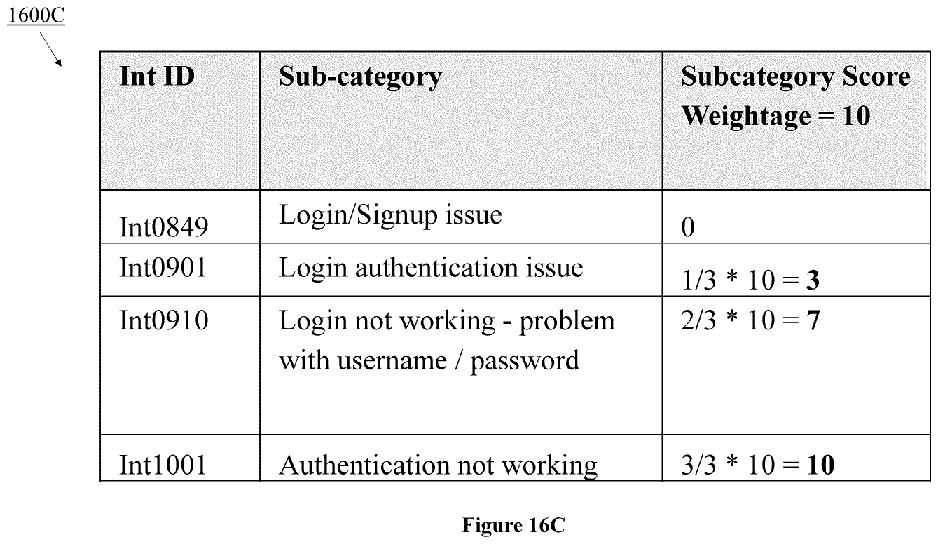

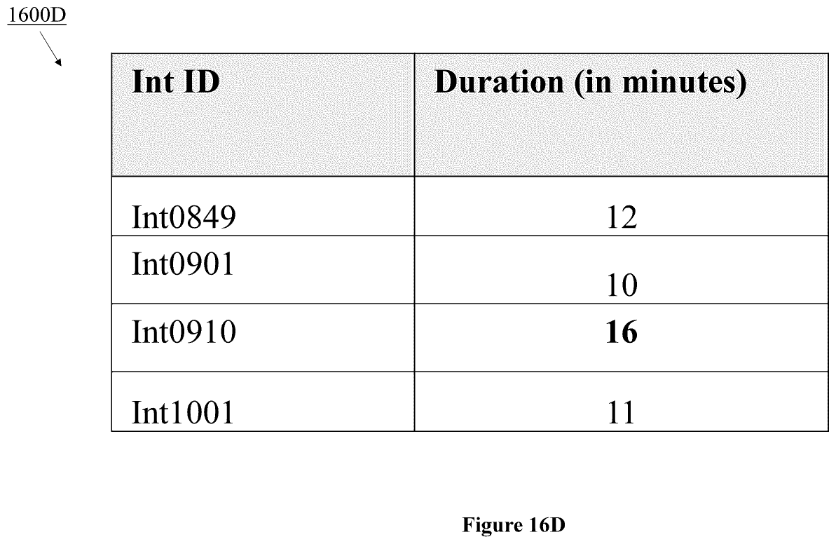

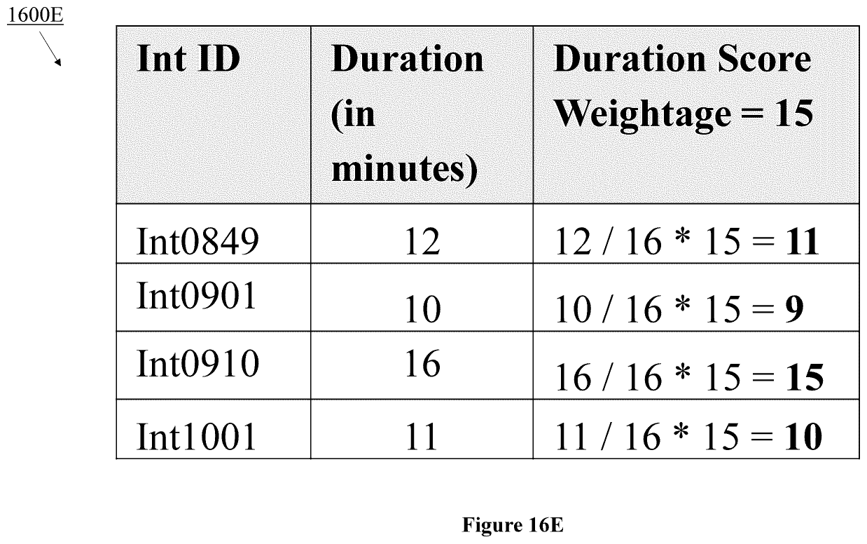

FIG. 16A is an example of a new interaction for which a RTIS score will be calculated, in accordance with some embodiments of the present invention.

According to some embodiments of the present disclosure, and agent may start a new interaction with the details in 1600A. Then, for the new interaction 1600A, a request may be sent with the context of 1500D and RTIS scores may be calculated, as shown in example 1600B. Based on the scores, RTIS1001, RTIS0999, RTIS1000 and RTIS0998 may be the order in which the RTIS entries may be short-listed. Example 1600B shows the RTIS score calculation by a master table containing all individual scores updated.

FIG. 16C is an example of relevance score calculation, in accordance with some embodiments of the present invention.

According to some embodiments of the present disclosure, the relevancy score calculation may be a sum of: (i) agent feedback score; (ii) dynamic context score, (iii) interaction category score; and (iv) interaction keyword score. The interaction category score may be associated with weightage 10, meaning, direct match of category which will be either 10 or 0.

The interaction keyword score may be associated with weightage 10, meaning the number of word matches in RTIS entry's interaction's sub-category divided by the total number of words in new interaction*Interaction keyword weightage. The sub-category is “Authentication not working”, where number of words is 3.

FIG. 16D is an example of duration in minutes of an interaction of existing RTIS entries, in accordance with some embodiments of the present invention.

According to some embodiments of the present disclosure, the relevance score may be a sum of agent feedback score+dynamic context score+interaction category score+interaction keyword score. The recency score may be associated with weightage of 20. The recency score may arrive by sorting the top 100 RTIS entries in order of time of occurrence, recent ones first. The batch size divided by the weightage may determine the percentage of entries to which a score would be assigned.

According to some embodiments of the present disclosure, for example, for 100 RTIS entries, 100 entries divided by 20 i.e., weightage, equals 5. Accordingly, the top 5% of the RTIS entries would get score of 20, next 5% would be 19 and so on. When the duration weightage is 15, then when calculating the duration score by duration of interaction of the RTIS entry divided by maximum duration multiplied by duration weightage when the maximum duration is 16 the duration score may be shown by table 1600E.

According to some embodiments of the present disclosure, the overall recency score is a sum of recency score and duration score. The line-of-business score may be calculated by summing line of contact score*line of contact weightage, department score*department weightage, and region score*region weightage. When, the weightage of line-of-business is 10, the weightage of department is 10 and the weightage of region is 5. The line of contact score equals ‘1’ when line of contact of RTIS entry matches interaction line of contact of the second interaction and when interaction line of contact of RTIS entry doesn't match interaction line of contact of the second interaction line of contact score equals ‘0’, department score equals ‘1’ when department of RTIS entry matches department of the second interaction and when department of RTIS entry doesn't match department of the second interaction department score, equals ‘0’, and region score equals ‘1’ when region of RTIS entry matches region of the second interaction and when region of RTIS entry doesn't match region of the second interaction, region score equals ‘0’, and the sum of line of contact weightage, department weightage and region weightage equals ‘1’.

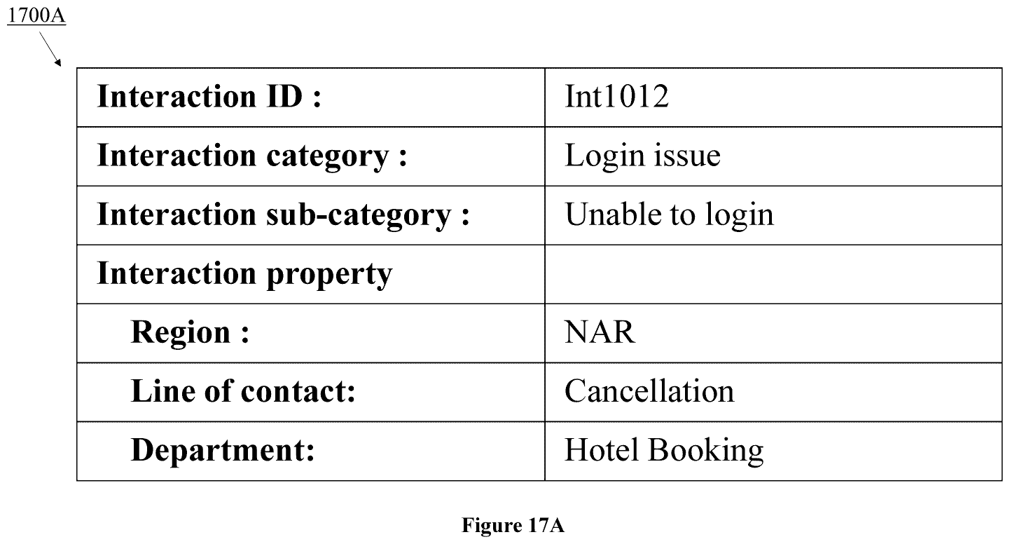

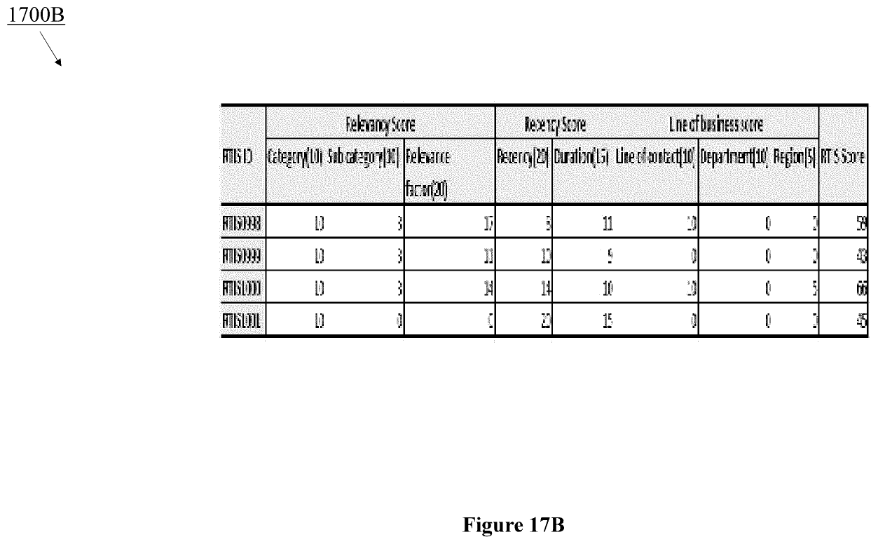

FIG. 17B is an example of selected RTIS entries for an interaction, in accordance with some embodiments of the present invention;

According to some embodiments of the present disclosure, the RTIS entries with scores calculated for interaction 1700A in FIG. 17A. For interaction Int1012, in FIG. 17A based on the scores, RTIS1000, RTIS0998, RTIS1001 and RTIS0999 is the order in which RTIS entries may be short-listed.

FIG. 18A is an example of a screenshot of a GUI of an RTIS board containing contextual information, in accordance with some embodiments of the present invention.

According to some embodiments of the present disclosure, the RTIS board, such as RTIS board 140 is the panel that is presented to the agent that contains the contextual information pertaining to the interaction. This panel e.g., screenshot of a GUI of RTIS board containing contextual information 1800A, has RTIS entries presented as problems and resolutions together with option for the agent to vote the entry up/down. There can also be features added like displaying category and sub-category that the interaction belongs to. Features like search and pagination can also be implemented for the RTIS board, so the agent has option to view any other relevant information dynamically.

FIG. 18B is an example of a screenshot of a GUI of an RTIS entry, in accordance with some embodiments of the present invention.

According to some embodiments of the present disclosure, when an agent decides to disposition interaction details having a problem and solution as an RTIS entry, there may be an option available for the agent to enter the problem and resolution together with categorization of the same.

It should be understood with respect to any flowchart referenced herein that the division of the illustrated method into discrete operations represented by blocks of the flowchart has been selected for convenience and clarity only. Alternative division of the illustrated method into discrete operations is possible with equivalent results. Such alternative division of the illustrated method into discrete operations should be understood as representing other embodiments of the illustrated method.

Similarly, it should be understood that, unless indicated otherwise, the illustrated order of execution of the operations represented by blocks of any flowchart referenced herein has been selected for convenience and clarity only. Operations of the illustrated method may be executed in an alternative order, or concurrently, with equivalent results. Such reordering of operations of the illustrated method should be understood as representing other embodiments of the illustrated method.

Different embodiments are disclosed herein. Features of certain embodiments may be combined with features of other embodiments; thus, certain embodiments may be combinations of features of multiple embodiments. The foregoing description of the embodiments of the disclosure has been presented for the purposes of illustration and description. It is not intended to be exhaustive or to limit the disclosure to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the disclosure.

While certain features of the disclosure have been illustrated and described herein, many modifications, substitutions, changes, and equivalents will now occur to those of ordinary skill in the art. It is, therefore, to be understood that the appended claims are intended to cover all such modifications and changes as fall within the true spirit of the disclosure.

What is claimed:

1. A Real-Time Information Sharing (RTIS) platform for maintaining a dynamic knowledge base, said RTIS platform comprising:
a computer system having one or more processors;
a Real-Time Information (RTI) database;
a plurality of computerized-devices,
wherein each computerized-device of the plurality of computerized devices is associated with a user of a plurality of users, and
wherein the computer system is configured to communicate with each computerized-device in the plurality of computerized-devices,
said one or more processors are configured to operate a Real-Time Information Sharing (RTIS) engine, said RTIS engine comprising:
(i) detecting termination of a first interaction of a first user to display via a Graphical User Interface (GUI) that is presented on a display unit, an option to mark information as to a resolution to a problem that has been provided during the first interaction for entering the resolution to a RTIS entry;
(ii) receiving a marked RTIS entry via the GUI from the first user and storing the marked RTIS entry in the RTI database,
wherein the display unit is associated to a computerized-device in the plurality of computerized-devices;
(iii) retrieving a batch of RTIS entries from the RTI database to calculate a score for each RTIS entry in the batch, based on one or more parameters,
wherein the score indicates relevance, recency and line of business of information in the RTIS entry, and
(iv) displaying a preconfigured number of RTIS entries via the GUI based on the calculated score of the RTIS entries upon receiving a request for display, when a second interaction of a second user starts.

2. The RTIS platform of claim 1, wherein each RTIS entry includes information that has been provided to a customer during the first interaction, wherein the information is not included in a static knowledge base.

3. The RTIS platform of claim 1, wherein the RTIS entries are filtered based on creation date, subject and line of business.

4. The RTIS platform of claim 3, wherein the RTIS entries are displayed from recent date to old date, and wherein the subject and the line of business are selected by the second user.

5. The RTIS platform of claim 1, wherein the displayed RTIS entries are RTIS entries having highest scores.

6. The RTIS platform of claim 1, wherein the calculating of the score of each entry is performed by formula I:
score=(a)relevance score*weightage1+(b)recency score*weightage2+(c)line-of-business score*weightage3 (I)
whereby:
(a) relevance score is a sum of: (i) agent feedback score; (ii) dynamic context score, (iii) interaction category score; and (iv) interaction keyword score,
wherein the agent feedback score is calculated by formula II:
agent feedback score=number of votes/max_votes*agent feedback weightage, (II)
whereby:
number of votes is a number of upvotes subtracted by a number of downvotes,
max_votes is a maximum number of votes from top preconfigured number of RTIS entries, and
agent feedback weightage is a configurable weight,
wherein the dynamic context score is calculated by formula III:
dynamic context score=number of interactions per department/max interactions in a department in the batch*dynamic context weight (III)
wherein interaction category score equals ‘1’ when interaction category of RTIS entry matches interaction category of the second interaction and when interaction category of RTIS entry doesn't match interaction category of the second interaction, interaction category score equals ‘0’,
wherein interaction keyword score is calculated by formula IV:
interaction keyword score=number of words in the stored RTIS entry which matches a subcategory of the interaction/total number of words in the subcategory of the interaction*interaction keyword weightage, (IV)
wherein the sum of agent feedback weightage, dynamic context weight, recency weightage and interaction keyword weightage equals ‘1’,
(b) the recency score is calculated by summing recency entry score and duration score
whereby:
recency entry score is calculated by formula V:
recency entry score=preconfigured number of recent entries/(recency weightage*100) (V)
duration score is calculated by formula VI:
duration score=duration of interaction of the RTIS entry/maximum duration of interaction in the batch*duration weightage, (VI)
wherein the sum of recency weightage, and duration weightage equals ‘1’,
(c) the line-of-business score is calculated by summing line of contact score*line of contact weightage, department score*department weightage, and region score*region weightage,
whereby:
line of contact score equals ‘1’ when line of contact of RTIS entry matches interaction line of contact of the second interaction and when interaction line of contact of RTIS entry doesn't match interaction line of contact of the second interaction line of contact score equals ‘0’,
department score equals ‘1’ when department of RTIS entry matches department of the second interaction and when department of RTIS entry doesn't match department of the second interaction department score, equals ‘0’, and
region score equals ‘1’ when region of RTIS entry matches region of the second interaction and when region of RTIS entry doesn't match region of the second interaction, region score equals ‘0’, and
wherein the sum of line of contact weightage, department weightage and region weightage equals ‘1’ and wherein the sum of weightage1, weightage2 and weightage 3 equals ‘1’.

7. The RTIS platform of claim 1, wherein said RTIS engine further comprising displaying via the GUI, that is presented on a display unit, an option to pin RTIS entries to be included in the preconfigured number of RTIS entries regardless of the score of the RTIS entry.

8. The RTIS platform of claim 6, wherein said RTIS engine further comprising updating the relevance score of the RTIS entries every preconfigured time.

9. The RTIS platform of claim 1, wherein the option to mark information provided during the interaction for conversion to a RTIS entry is displayed based on duration of the interaction and context thereof.

10. The RTIS platform of claim 1, wherein said RTIS engine further comprising receiving a supervisor approval before the receiving of the RTIS entry via the GUI from the first user.

11. The RTIS platform of claim 6, wherein said RTIS engine further comprising enabling a user to vote up or vote down, via the GUI, for each displayed RTIS entry.

12. The RTIS platform of claim 1, wherein said RTIS engine further comprising checking every preconfigured time-interval the calculated score of RTIS entries which were received in last preconfigured time-interval to determine a preconfigured percentage of the RTIS entries having highest score, wherein the determined preconfigured percentage of the RTIS entries are sent to an invoked expert Application Programming Interface (API) for creating a how-to article from the determined RTIS entries.

13. A computerized-method for maintaining a dynamic knowledge base via a Real-Time Information Sharing (RTIS) platform, said computerized-method comprising:
(i) detecting termination of a first interaction of a first user to display via a Graphical User Interface (GUI) that is presented on a display unit, an option to mark information as to a resolution to a problem that has been provided during the first interaction for entering the resolution to a RTIS entry;
(ii) receiving a marked RTIS entry via the GUI from the first user and storing the marked RTIS entry in the RTI database,
wherein the display unit is associated to a computerized-device in the plurality of computerized-devices;
(iii) retrieving a batch of RTIS entries from the RTI database to calculate a score for each RTIS entry in the batch, based on one or more parameters,
wherein the score indicates relevance, recency and line of business of information in the RTIS entry, and
(iv) displaying a preconfigured number of RTIS entries via the GUI based on the calculated score of the RTIS entries upon receiving a request for display, when a second interaction of a second user starts.
